(19) United States
(12) Patent Application Publication
(10) Pub. No.: US 2019/0073342 A1
(43) Pub. Date: Mar. 7, 2019

(54) PRESENTATION OF ELECTRONIC INFORMATION

(71) Applicants: Eric Cameron Wilson, Benloch (AU); Daniel Lawrence Wilson, Nulla Vale (AU)

(72) Inventors: Eric Cameron Wilson, Benloch (AU); Daniel Lawrence Wilson, Nulla Vale (AU)

(21) Appl. No.: 16/083,520

(22) PCT Filed: Mar. 13, 2017
(86) PCT No.: PCT/AU2017/000062

§ 371 Date: Sep. 10, 2018

(30) Foreign Application Priority Data
Mar. 11, 2016 (AU) 2016900922
Apr. 16, 2016 (AU) 2016901425

(51) Int. Cl. G06F 17/21; G06F 17/22

(52) U.S. Cl. CPC G06F 17/217; G06F 17/2247; G06F 17/2235; G06F 17/218

(57) ABSTRACT

A computer acting as display device can present pixmap screen page image(s), and with end-user input, can act on associated interaction(s) area(s) specification(s); with the screen page image(s) and associated interaction(s) area(s) specification(s) created automatically from electronic document processing on another computer; such other computer paginating the documents for information viewing area(s) on such display device(s), record interaction(s) area(s) data corresponding with styled hypertext or interactive graphical elements within the electronic document, rasterising these document page(s) into screen page image pixmap(s), and compile interaction(s) area(s) data into persistent interaction(s) area(s) specification(s), together for communication to the display device. References to content elements in document pages can be associated with screen page images to allow end-users find information. Content elements in documents may act as placeholders in pagination to reserve space for overlaying media upon screen page images. Screen page images may consist of many pixmap files to prevent end-user saving.

### BACKGROUND

Most end-user computing devices output to some kind of display, such as (but not limited to) one or more Liquid Chrystal Display(s) (LCDs) and have inputs such as (but not limited to) buttons, mice, touch pads, touch displays, cameras, game controllers, motion detectors, keyboards and voice/sound recognition, for example. Without limitation, examples of these devices include Android Tablets, Apple iPhones, Smart Watches, Windows PCs, virtual desktops accessed via remote display protocols, and Sony PlayStations; Cameras and even cars now incorporate end user computing devices.

Such end user computing devices, are used to display text and/or graphical elements (which graphical elements include pictures diagrams and other static artwork) to end users. Graphical elements also include placeholders—such as for streaming/dynamically-generated or statically linked media/applications/widgets (media being content such as video, slide-shows pictures, drawings etc.)—the data for which may be stored locally on an end user computing device or accessed via a computer network for example. Placeholders may also be represented by characters, such as one or more blank underline characters (e.g. ASCII code 242) or underlining dashes, conventionally used to denote where a user should fill information in. Likewise, placeholders may be represented by conventions such as a pair of braces [ ] indicating a check box, brackets with a space inside ( ) or number inside (2) indicating a multiple choice element to be selected, or various symbol font glyphs, for example.

These textural and/or graphical elements are collectively and individually referred to in this specification as “Content Element(s)”. The electronic expression of one or more of such Content Elements constitutes an electronic document (hereafter termed “Document”). In this specification, the term “Document” also refers to any inclusions, linked or embedded Content Elements that are ultimately intended to be presented to an end user. Whole page scans may be bound together to form a Document, such as those conforming to the ISO 32000-1:2008 standard for example.

In this specification, content originators (such as authors, photographers and artists) and publishers who produce or distribute content online, are collectively referred to as “Publishers”.

End user computing devices, as well as general-purpose digital computers, run programs on one or more central processing units, which store such Content Elements and Documents in computer memory (such as RAM, ROM, magnetic or optical disk). They also transmit and/or receive (communicate) Content Elements and Documents with each other over computer networks such as the Internet, intranets or peer-to-peer protocols utilizing wired, optical or wireless networking infrastructures (or any combination of these). They can also share information by way of portabe storage such optical disk or flash memory.

Such storage and communication of Content Elements in the form of text data (e.g. characters and glyphs) are usually directly represented by numbers. An early example of this is the American Standard Code for Information Interchange (ASCII) where for example, the letters “a” to “z” correspond to the numbers 97 to 122. Such numbers are able to be stored within a seven or eight-bit scheme (comprising 128 and 256 numbers respectively) known as a character set. Larger character sets have since been developed.

The alternative is to store characters as small images. Each such glyph may be represented by an array of pixels, so that a very rough-looking glyph may be represented in a grid of 4×5 pixels—amounting to 20 bits for a monochrome-only representation. Such a grid is known as a “bitmap” or “pixmap” if the pixels also comprise colour information. Pixmaps/bitmaps may be persisted in files such as but not limited to various GIF, JPEG & PNG file formats stored on persistent media such as magnetic or optical disks or as “blobs” in databases for example.

From these examples (kept somewhat simple for ease of explanation) it can be seen that encoding characters into a character set can save on communication and storage requirements when compared with pixmaps (as far character sets go), regarding both end-user computing devices and general-purpose digital computers. Furthermore, character encodings can be used to convey simple formatting information, such as spacing. For example, ASCII number 13 represents a carriage return.

However, many of today's fonts utilising character encodings and installed or used in computer systems (such as both end-user computing devices and general purpose digital computers), are not mere character codes representing pixmaps but formulas (vector graphics) which are executed so as to create bitmaps/pixmaps. This allows fonts to scale between very large type and smaller type, and to be be tailored to suit the medium on which they are to be outputted and read. In this case, not only a character code is required but also its font must be specified for a “run” (a number of characters) of “styled text” (which may also contain colour, layout information, etc. in addition to specifying a font) to be understood, or else the computer system's default (fallback) font will often be applied instead.

Despite savings in storage and communication costs of styled text (e.g. being character code(s) with font(s) colour(s), formatting(s), and/or any other metadata associated with text), the common practice of encoding characters and fonts to create such styled text has a number of disadvantages:

Storing and communicating characters in encoded form requires agreement between computers on what the encodings mean. This can be problematic because many human languages have different encodings and to confound this, many general purpose digital computers, and even end-user computing devices, need to handle information recorded in more than one human language. To solve this problem, different encoding standards have emerged. However even today, there is no standard way of specifying the encoding of text files when uploaded by an end-user's Web browser to an online publishing service for example. This means computer systems sometimes need to analyse the bits that represent characters to see if by pattern recognition the correct encoding can perhaps be deduced, which is not always successful.

An example of a common situation where character encoding goes wrong is with apostrophes. A straight apostrophe “does not share the same character encoding as a left curly apostrophe ” or a right curly apostrophe” the latter two ‘curlies’ being sometimes known as “smart quotes”. Smart quotes are not part of ASCII (for example) and when they are encountered by computer systems employing character encodings that are not “smart quote aware”, a run of garbage characters such as â€™ often results. A search on Google.com returns tens of millions of matches for the otherwise unlikely â€™ run of styled text, which is indicative of the many errors caused by the existence of multiple text encodings even expressing the same human language(s).

In days gone by, this was not such a problem because such styled text was often stored and displayed by the same computer system; but today, billions of end-user computing devices receive styled text from general purpose digital computers via computer networks such as the Internet. And the above example is trivial compared with cases where an entire Document (or parts of it) is effectively scrambled in popular Web browsers because the encoding of its text is unknown. However, an article entitled “Choose text encoding when you open and save files” provides a manual solution for users of the Microsoft Word 2010, 2013 & 2016 word processor involving manual selection of the correct encoding when opening or saving a Document. (The article's URL is https://support.office.com/en-ca/article/Choose-text-encoding-when-you-open-and-save-files-60d59c21-88b5-4006-831c-d536d42fd861). This may still be needed despite the automatic encoding introduced in Word 2000 to address the issue (See https://support.microsoft.com/en-us/kb/217198).

Assuming the character encoding of text is known, the task of drawing characters onto a screen involves the application of a font (to allow the characters of text to be rasterised and viewed). This too usually requires agreement between computer systems on what font applies to which characters. For example, a bold font is separate from an italic font, just as a Ubuntu Condensed font is different from a Tahoma font. And because fonts are in effect artwork software protected by copyright, computer software makers don't always share their fonts with rival systems, and in any case even free systems employ differing fonts as a matter of preference. In such cases, a computer system will substitute a missing font for a hopefully close-looking available font (e.g. in at least Microsoft Word 97 onward). At times this is not possible, and the substitute font may not even be the same size of the original, leading to unforeseen layout changes not intended by a Publisher.

A solution to the problem of font substitution is to embed fonts within Documents or link fonts for possible download, to allow them to be read on end-user computing devices when a Document is used. For example, FIG. 6 sets out the HTML code of the default page of example.org, which is maintained by the Internet Assigned Numbers Authority according to RFC 2606 (Network Working Group) and RFC 6761 (Internet Engineering Task Force). The Document employs UTF-8 character encoding (see HTML elements 047, 048 in FIG. 6 herein) plus specifies a number of fonts 049 which may be used to turn the Publisher's characters 053 of that specified encoding into human-readable glyphs within a Web browser for example. The flow of such styled text (see aspects 047, 048, 049, 051, 052) is modified by spacing 050 in FIG. 6. The styled hypertext 054 will also have its colour changed 051 if the location specified in the link data 054 has been “visited” before. This system of Document presentation is complex for such a simple Web page; and because fonts effectively execute on computers so as to be “drawn” on screen, linked or embedded fonts can contain risky malware. Such formatting and fonts also increases Document memory and communication requirements.

Furthermore, there are differences in rasterisation techniques used to convert fonts to displayable pixels between different computer operating systems. Indeed, applications running on a particular end-user computing device may use one of several raterisers offered by the same operating system, such as can be the case in Microsoft Windows. Such differences between rasterisation techniques can introduce variations in how well Documents are presented on screen, even if there is agreement between computer systems as to what the character encoding and font information of styled text represents. As a simple example, FIGS. 12 & 13 herein depicts the same Content Elements of FIG. 11 in different Web browsers that are running on the same Microsoft Windows 8.1 end user computing device at the same time. However, when comparing FIGS. 12 & 13 the same styled text of the same HTML code has been rendered with different sizes and interline spacings to produce different formattings. This can be particularly problematic for artwork including advertising upon which the online publishing industry relies.

In other words, even without errors, the disposition of Content Elements can vary considerably even between applications on the same end-user computing device, meaning Publishers are at the mercy of these applications in the presentation of information. This causes differences in pagination of the same content even on the same computer, so that it is possible even that a different number of pages may be produced from the same Document paginated to the same page size(s). This unpredictability contributes towards a lack of pagination of online information which in tern causes distracting end-user scrolling that can impact reading comprehension. This is despite styled text pagination being known to the art for decades.

One way around the inconsistent pagination and other difficulties associated with styled text, employs remote display protocols known to the art since the 1980's (and made more widely available in Microsoft Windows in 2001), to publish one's own application that presents Documents; however this method requires a constant server connection and for the Publisher to maintain on a server a separate graphical user interface for end user or Document display. Doing this is computationally expensive. It also requires a very responsive network, since live events such as mouse events and screen updates are transmitted from the display application to the remote display device to be handled in real-time. Such a low-latency network may not be available if an end user computing device is connected to the internet for example, via a cellular or satellite network as is often the case.

So despite the lack of precision in rasterisation between computer systems and their applications—and all the other compatibility problems with styled text—character encoding schemes are nevertheless widely used today; with their fonts and other formatting information—such as interline and inter-paragraph spacing, margins, and data specifying which font applies to which characters and in what colour and other meta-data. All this greatly bloats the amount of memory required (and thus download times) to represent modern textual information. The Internet Engineering Task Force reports 50% of Web sites employ such fonts despite not yet being an official content type, and having the previously mentioned security and compatability concerns (The Font Primary Content Type draft, C. Lilley, IETF, 16 Oct. 2015). It has reached the point where Google now provides a free online estimator of how much bandwidth fonts will consume to help Web designers not imperil the online end user experience or inflate bandwidth costs.

Finally, even if all computer systems are in agreement and all Document rasterisation is somehow made consistent between them, and all programs lay out all Documents in the same way—this being highly unlikely—the popular HTML protocol in particular is still prone to interception and manipulation in Web browsers against Publisher intentions. (Likewise Documents in other display programs can be laid out at the discretion of those programs and user preferences therein). Thus Documents are an inherently insecure information medium. For example, in Web browsers, users can switch off style sheets, install ad-blockers or view content in reading modes (such as in the Mozilla Firefox and Microsoft Edge web browsers) leading to the Publishers' intended content elements being removed or otherwise compromised. A report in the Wall Street Journal (10 Aug. 2015) estimated the annual revenue loss to the online publishing industry caused by ad-blockers alone was U.S.$22 billion.

On the other hand, with efficient compression of pixmaps in standard file formats such as the Portable Network Graphics ISO/IEC 15948:2004 (referred to herein as “PNG”), or JPEG File Interchange Format Version 1.02 Sep. 1 1992/Exif Version 2.2 JEITA CP-3451 April 2002 (separately and together referred to as “JPEG” herein), along with faster file downloading communications and inexpensive storage, it is feasable to share images of writing between computers rather than encodings, fonts and formatting.

The advantage of using standard image formats such as PNG or JPEG to record writing and to depict graphics, is that the errors, omissions, variations, management and security issues of styled text and any associated layout changes, can be minimised by confining styled text to computer systems within the control of Publishers. The disadvantage is that it is much more difficult to reprocess or modify writing if it's stored and communicated as an image rather than encoded as styled text. The other problem is transforming screen page images to different shapes and sizes to suit different screen sizes and viewing distances often distorts what they depict, so that writing becomes difficult to read or even unreadable for example.

Despite these limitations, the conversion of pages of Documents into image files is well-known to the art using standard techniques. For example, since at least October 2001 Microsoft Window's Graphics Device Interface Plus (Windows XP GDI+) has been commonly programmed by software developers to image fonts to pixmap/bitmap outputs such as JPEG or GIF; and since at least October 2007 end users of the GIMP image editor (version 2.4) have been able open PDF files (conforming to the Portable Document Format Reference Manual Version 1.2, Nov. 27, 1996 by Adobe Systems Inc.) and convert them into multiple pixmaps which could be then exported by them as JPEG or GIF files. However, when this is done to hypertext, the functionality of the hyperlinks is lost because it is not recorded in the pixmap, and there are billions of Documents which contain/include styled text as hypertext (“styled hypertext”) in Hypertext Markup Language (HTML), word processing files, and Portable Document Format (PDF) files, and the like.

Such hyperlinks, of course, allow end-users to access other Content Elements and Documents, or navigate to bookmarks within a Document using a viewing application, or trigger some other action. Furthermore, many Documents with styled hypertext also contain/include graphical elements (either linked into the Document or embedded within its data structure(s)) such as pictures or drawings; which graphical elements (hereafter “interactive graphical elements”) may have link data to other Content Elements, Documents or actions. Such link data (such as but not limited to URLs)—which will be lost in any rasterization of Content Element(s) into a pixmap—is an indispensable part of the online user experience. Consequently, simply rasterizing Documents containing/including hypertext or interactive graphical elements into JPEG images as known to the art—or other pixmap/bitmap file formats (such as Tagged Image File Format as in the TIFF 6.0 Specification 3 June 1992)—is not a viable option, because the interactivity of link data would be lost in the conversion.

The industry-standard way of associating link data with an image file (such as JPEG or PNG file) is to use an image map to specify how a Web browser should handle end-user interaction with area(s) in the image. Image maps are a somewhat disused way of associating link data with a JPEG and other image file types. An image map correlates one or more areas in an image by providing each area with a hyperlink (for example) by using a coordinate system associated with link data, link data being such as (without limitation) a URL or Click-To-Call (“tel:”) schema or other action(s). Such image maps may have the advantage of not requiring a Web server to perform an action triggered by an end user's selection of a portion of the image displayed on an end user's computing device, although they can be configured to do so.

Since at least 1997 onward (e.g. HTML 3.2 Reference Specification 14 January 1997), image maps have been incorporated into Web pages to be used in conjunction with GIF, JPEG and PNG files (and later with JavaScript and CSS techniques). Proprietary plug-ins/applets such as Flash by Adobe Systems Inc. may be used to similar effect, however these can require downloading and installation by end-users and are unavailable for many end-user devices. Standards-based combinations such as JPEG file(s) with image map(s) are therefore often to be preferred, having been perpetuated (despite somewhat infrequent use) substantially unchanged through to 2014 and beyond with HTML 5 (28 Oct. 2014).

However, the geometric disposition of regions occupied by styled hypertext within Document data if properly converted into image maps, would often be complex and varied. This is because each run of styled hypertext can create several disconnected regions after text flow is complete—such as caused by hot-spot gaps between interline spacing; when displayed in the Firefox Web browser by Mozilla for example, the mouse cursor may change from a clickable hand to an ordinary arrow pointer between lines of hypertext. Interline hotspot gaps may also occur (such as in the Firefox Web browser) when a run of styled hypertext that is shorter than the width of the styled textflow, is broken into two by text wrapping. With left or right justification, 8, 6 or 4-sided hypertext regions are possible depending on wrapping (or not), assuming the absence of any interfering interline spacing which cannot be assumed. However if the styled hypertext is center-justified, the disposition of the resulting region(s) of interactivity can be much more complex. Moreover, each page may have a dozen of such hotspots if for example, the page also contains linked references in footnotes. Because of these considerations, manual mapping or selection methods provide no practical way of either economically, or in a timely fashion, dealing with the number and variety of hotspot dispositions found within whole Documents.

One patent regarding the automatic generation of image maps is U.S. Pat. No. 8,706,572 “Generating product image maps” in the name of Varadarajan. This optically recognizes products and text in images and create an image map corresponding to them. However, Varadarajan's input data consists only of images not Documents with styled hypertext and/or interactive graphical elements (e.g. hyperlinked to other Content Elements expressed in HTML code). Thus Varadarajan neither countenances nor assists the problem of making images of, and image maps of, whole pages from Documents containing Content Element(s).

It will also be appreciated that areas of interactivity (hot-spots) related to styled hypertext can be difficult to ascertain. For example, a hyperlink in a word processor program running on an end-user computing device may be related to styled text not directly by coordinates of geometric displosition but via character positions (numbers) in one or more streams of characters held in memory which characters may be hit tested when on screen. Likewise styled hypertext in HTML is not associated by any coordinates but by a set of tags, e.g.:
<h1><a href=“http://uspto.gov”>Link to USPTO</a></h1>

Thus the geometric disposition of ‘hotspots’ caused by styled hypertext within a Document may never be directly associated with a hyperlink. This may be because the execution of a hypertext link may be conditional on its character(s) receiving a hit (e.g. touched or clicked on), if and when those characters are displayed on screen—since before this the text flow may dynamically change. For example, styled hypertext within a word processor may well move if characters are typed before the styled hypertext or the page is resized, margins adjusted or justification and other paragraph settings are changed. Likewise, styled hypertext displayed in a Web browser may be reflowed to fall into a new position if the browser width is changed or if “reader mode” is invoked such as in the Firefox Web browser by Mozilla. So when it comes to the disposition of hotspots, styled hypertext is often a moving target. Indeed, the use of the same Document may be by way of different rasterisations suited to different output devices. This means even page coordinates stored as annotations in PDF files are subject to adjustment according to the display context.

Further, the extent to which such event-driven resolution of styled hypertext interactivity occurs, often depends on whether or not particular pages are actually loaded for viewing. For example, for efficiency, word processors and PDF readers can avoid Document imaging completely except for those Content Elements being or about to be viewed. So with long Documents in particular, the precise disposition of only a relatively small number hotspots, having been transformed from “user space” (in the case of PDF) or character stream positions (e.g, with word processors) might be able to be tested to obtain page coordinates at any particular time.

End-user applications which handle styled hypertext are thus completely ill-equipped to convert pages of Documents into image files with image maps: None of the prior art discloses automatic Document repagination and conversion into screen page image files with image maps or other image map-like data or specification. Additionally, the prior art does not create hyperlinks in image maps that link screen page image files(s) derived from a Document's pages to each other, to reproduce the effect of internal Document navigation (such as with bookmarks).

What is needed is a system and method of converting styled hypertext and interactive graphical element(s)—as found in billions of Documents worldwide—into standards-compliant screen page image files(s) free of encoding, formatting and font issues/limitations, while preserving their internal and external hyperlink references (and actions), without browser plugins or applets. This needs to be done in a way which improves both the pagination of online information and Publisher efficiency.

### BRIEF DESCRIPTION

The invention relates to the field of information preparation suitable for information viewing areas on end-user computing devices, that is performed on one or more server computers (such as a general purpose digital computers or another end user computing device acting in that capacity). It also relates to the display of such information on end user computing devices.

It is an object of the invention to automatically transform information into a form free of character encodings, fonts and other textural formatting, while both preserving its appearance and the effect of actions associated with any link data; and to provide information presentations compatible with a very wide range of end user computing devices or computer programs. A further or alternative object of the invention is to improve Publisher control over information. Another further or alternative object of the invention is to improve the online readability of information. Another further or alternative object of the invention is to improve the online readability of information. Another further or alternative object of the invention is to allow end users to better interact with online information.

Without limitation: The object(s) of the invention may be obtained by automatically transforming a Document's styled hypertext into persistent screen page image(s) in conjunction with persistent interaction(s) area(s) specification(s), so as to greatly reduce dependence on styled text and styled hypertext while preserving the effect of link data. The invention may also attain its object(s) by automatically incorporating a Document's interactive graphical element(s) into a transformation into screen page image(s) with interaction(s) area(s) specification(s) to preserve the geometric disposition(s) of hotspots and the effect of link data. In preference (but without limitation), the object(s) of the invention may be met by such automatic transformation of a suitably paginated Document's styled hypertext and/or interactive graphical elements, as the case may be—in conjunction with persistent interaction(s) area(s) specification(s).

It will be appreciated that in all cases throughout the disclosure of the invention, the display of screen page image(s) on end-user computing device(s) as an outcome of the invention, may be in a succession and if required, and multiple screen page images may be displayed at once as screen columns of screen page images (but this doesn't preclude the possibility of an individual screen page portraying multiple columns). Throughout the disclosure of the invention, the term pixmap may also be taken to include a bitmap. Also throughout the disclosure of the invention, the terms “screen page image file”, “pixmap file” and “bitmap file” mean a digital data file (such as a PNG, JPEG or TIFF file for example), which contains one or more screen page images (or parts thereof). Likewise the term URLs includes URLs with query strings or hash tags, and other reference mechanisms known to the art.

In one form, the invention resides in a system of computer implemented automatic screen page image file and end user interaction areas(a) specification(s) creation, including:
One or more computer systems each running at least one program (altogether termed “server processing means”) wherein:
   (a) at least one Document(s) is obtained from computer memory (such as using Web, email or ftp server program(s)) or other digital source(s)); and
   (b) such Document(s) may be paginated into one or more page(s) if not already suitably paginated so that pages are suitably sized for information viewing area(s) on an end-user computing device(s) and/or within program(s) running on those devices; and
   (c) locations and dimensions of any Content Elements having link data are detected and recorded as coordinate data relative to their respective page(s) within the Document, where the coordinate data associated with corresponding link data is assembled to create related interaction(s) area(s) specifications(s)—such as image map(s)—to persist a representation of any interactivity aspects of Content Elements on a Document's pages; and
   (d) the Document's page(s) are rasterised to produce persistent screen page image(s) that are independent of the Document and its contents;
   (e) copy(s) of those persistent screen page image(s), and copy(s) of their corresponding interaction(s) area(s) specification(s), are provided (such as by being made available on a server computer via a computer network) for use by one or more end user computing devices;
wherein the detection of coordinates is determined by the server processing means by identifying and analyzing the Document's styled hypertext or interactive graphical element(s) within its page(s), or both styled hypertext or interactive graphical element(s), as the case may be;
wherein if a Document contains bookmark(s) then reference(s) in the link data of aspect (c) may refer to a screen page image(s) produced in aspect (d); and optionally
wherein the location(s) or dimensions or link data of the Content Element(s) of aspect (c) may refer to static/streaming/dynamically-generated media/applications/widgets/controls to be presented by an end user computing device such as overlaying screen page image(s) or parts thereof.

It will be appreciated that if more than one screen page image is stored in a screen page image file, any interaction area coordinates may be adjusted to be relative to the pixmap file in relation to the disposition of the relevant screen page image within that file. This may be done either by a program running on an end user's computing device (such as implemented using JavaScript) or by said server processing means.

Further, it will be appreciated that pagination may also take into account the magnification or zoom factor at which an end user may wish to view information. One way of achieving this is by scaling the desired screen page size (maintaining its aspect ratio) prior to pagination, then scaling the the resulting paginated pages back to that desired screen page size prior to rasterisation into screen page images.

The most comfortable magnification may be ascertained by an input gesture such as pinching/expanding on an end user computing device's screen, as is common to the art. After such a gesture the pagination process will be initiated on a server computer with “pagination magnification” to match or nearly match the level of magnification the user has zoomed to through the gesture. This unique way of adjusting magnification pagination has the advantage of allowing the user to dynamically preview the information magnified (or reduced by a magnification of less than 1) or approximate magnification of the information, and manipulate magnification to suit before magnification pagination is invoked.

A method for working out the adjusted magnification after a completed zoom gesture, is to obtain the display width (e.g. in pixels) of the screen page image after the gestured zoom has occurred (the displayed screen page image being now smaller or larger than before), and dividing this new value by the screen page image's previous width as it was prior to the gestured zoom, to produce a scale factor. The new magnification value by which screen page(s) will be scaled prior to a new magnification pagination as described above, is equal to the old magnification multiplied by the scale factor obtained from the zoom gesture. It will be appreciated that the height values of a screen page image may also be used to determine a scale factor, since aspect ratios are not altered by zooming. However the new page(s) to be created by magnification pagination may have a different aspect ratio (such as by reducing the number of columns of screen page images shown at once on the display device means's display area) to suit.

It will also be appreciated that the said Content Elements having link data in page(s) could be styled hypertext or graphical element(s) or both as the case may be; and that link data could be in the forms of URLs.

It will be further appreciated the said detection of coordinates corresponding to the location(s) and dimensions of any Content Elements having links may be done by (without limitation) means of character attribute testing (e.g. where characters are in a stream of characters) for associated link data with area calculation of such hyperlinked character(s); or by (without limitation) hypertext/hypertext background colouring with scanning of the coloured regions to obtain coordinates of their respective geometric disposition(s). Coordinates might otherwise be obtainable from positions/dimensions within a paged format or by calculating the positions and dimensions relative to each page using formatting information such as line heights, glyphs/fonts, kerning, leading, margins tab stops etc into account—where it is accurate to do so.

In a preferred embodiment the said coordinates (or other data) corresponding to the location(s) and dimensions of any Content Elements having links may be expressed as an image map, or colour mask of different colours against which the location of any user interaction(s) can be compared with link data associated with each colour value.

The system needs no styled hypertext or graphical elements to be present on end user computing device(s) because these are converted on server processing means to screen page images. Thus depictions of writing or graphics or both of them can be viewed by displaying copies of screen page image(s) with end user interaction being supported by copies of interaction(s) area(s) specification(s) provided in conjunction with the screen page image(s).

In a further form, the system may additionally include:
One or more end-user computing devices running one or more programs capable of presenting one or more screen page images (altogether termed “display device means”), wherein:
   (i) said screen page image(s) and related interaction(s) area(s) specification(s) are communicated from at least one said server processing means; and
   (ii) said interaction area(s) specification(s) specify coordinates (or colour mask) of one or more areas of said screen page image(s) to define one or more interaction(s) areas (hotspots) that may be smaller in size than an entire screen page image and which coordinates correspond to writing or graphic(s) depicted in the said screen page image; and
   (iii) said interaction(s) area(s) may trigger instant feedback (such as a change in the mouse cursor or display of a ‘tool tip’ known to the art) to end-user interaction associated with the interaction(s) area(s) presented on display device means; and
   (iv) end-user interaction related to said coordinates of one or more interaction areas of said screen page image(s) is executed by the said display device means for processing of the interaction (on the display device means or server processing means or both); and
wherein the said communication between the said display device means and said server 395 processing means is by way of a computer network such as the internet or an intranet;
and wherein:
   the said display device means may paginate placeholders to make space in said screen page image(s) for corresponding information overlays to be displayed in said display device means; and/or
   a delay handler for long Document pagination on the server processing means allows screen page image(s) associated with only partially completed interaction(s) area(s) specification(s) to be presented nonetheless using the incomplete interaction(s) area(s) data, which will be updated to the display device means when the target screen page image of a bookmark (and any other missing data pertaining to such internal references) becomes known to the server processing means.

It will be understood that any said instant feedback in said display device means (without limitation) may be a sound played or special effect applied such as to the particular interaction area concerned.

It will be further understood that said end user interaction with display device means may be (without limitation) mouse events, pressing, swiping, gestures, voice recognition, keystrokes or any combination thereof.

It will also be appreciated that without limitation, any response (e.g. instant feedback) to the end user given by the display device means could be the showing of a translucent overlay upon an portion of writing in a screen page image or a border around a graphic depiction, which may be drawn on a layer above a screen page image. Further or alternatively, the said feedback may include presenting options (such as within a context menu) related to where the link data may be used for processing, such as on the end user's computing device (e.g. to present a web page without the use of an embodiment of the invention in a new browser tab for example).

In a preferred embodiment, wherein the said instant feedback described in item (iii) above is provided, that instant feedback may be provided to more than one of the said interaction(s) area(s), such as where the said link data is common between them. This can occur for example, when said coordinates of a single run of styled hypertext create several said interaction(s) area(s) because the styled hypertext on the page in a Document wraps over several lines of styled text and where the styled hypertext does not span the column (or other styled text wrapping boundary) in which the styled hypertext lies.

In another form, the invention resides in a computer-implemented method of automatic screen page image(s) creation in conjunction with interaction(s) area(s) specification(s) including the steps of:
1) Obtaining Document(s) from repository(s) (such as may store email, web pages or files, and which may be located on an end user computing device or a general purpose digital computer) which Document(s) contains/includes styled hypertext or one or more interactive graphical element(s) (e.g. hyperlinked to other Content Element(s) or Document(s)), or containing/including both styled hypertext and such interactive graphical element(s), and as the case may be;
2) paginating said Document(s) into one or more pages (if not already suitably paginated), such as to suitable dimensions able to be viewed within one or more end user computing devices or programs thereof;
3) identifying any styled hypertext, and any interactive graphical element(s), in said pages(s);
4) rasterising said page(s) to create screen page image(s) of at least one said page and persisting said screen page image(s) in one or more pixmaps;
5) analysing any said identified styled hypertext or interactive graphical element(s) (if any) to obtain coordinates/colour mask describing the geometric disposition of hotspots relative to the said page(s) or pixmaps having screen page images;
6) associating said coordinates/colour mask with the link data obtained from each of the said styled hypertext and/or interactive graphical element(s) (if any) so as to create interaction(s) area(s) specification(s) (such as image map(s) for example);
7) persisting said screen page image(s) in conjunction with interaction(s) area(s) specification(s) related to said screen page image(s) and making said screen page image(s) and said related interaction(s) area(s) specification(s) available to end user computing device(s) via a computer network;

whereby in cases where the said Document contains bookmark(s) then reference(s) in the link data of step 5 may refer to a screen page image(s) produced by step 6; and optionally whereby the location(s) or dimensions or link data of any styled hypertext or any interactive graphical element(s) of step 3 may refer to static/streaming/dynamically-generated media/applications/widgets for presention by an end user computing device such as by overlaying on screen page image(s) or parts thereof.

Optionally, at least one end-user computing device is employed to select Document(s) to be obtained with 455 respect to step 1.

The pagination step of the method may also take into account the magnification or zoom factor at which an end user may wish to view information. Without limitation, this may be made known to the various embodiments of the invention by way of request(s) from an end user computing device(s), or from a list of supported zoom levels, or both of these.

It will be appreciated the said analyzing of any said styled hypertext or interactive graphical element(s), to obtain said coordinates, may be done (without limitation) by means of:
character attribute testing for hyperlink association combined with getting the location of characters (such as by sending cursor(s) to character locations(s) under program control and hit testing, and area calculation of hyperlinked character(s) such as with line heights etc, or
character attribute testing for hyperlink association combined with calculating font usage and dimensions with layout information, or
hypertext/hypertext background colouring with scanning: In particular embodiments of the invention the said coordinates corresponding to the location(s) and dimensions of any linked Content Elements may be expressed as an image map; or colour mask against which the location of any user interaction(s) can be compared with link data associated with each colour value, or converting an image map which defines region(s) in an interactive graphical element by adjusting the coordinates to be relative to the corresponding area of graphic depiction in the screen page image (or pixmap file), and adding these along with their link data into the interaction(s) area(s) specification(s) relating to the screen page image(s) or pixmap file(s), or
obtaining positions/dimensions within a paged format if these are already available as part of the format, or
calculating the positions and dimensions relative to each page using formatting information such as line heights, glyphs/fonts, kerning, leading, margins tab stops etc into account (this method although possible may be complex and computationally expensive and in some cases results may not exactly match up with a rasterised screen page image), or
one or more combinations of the above means of ascertaining coordinates.

The steps of identifying and analyzing styled hypertext may be conducted in sequence from the start of the Document to the end of the Document or in any order that may be automated, provided always the relationships between page(s) (including in pixmaps) and any corresponding coordinates and associated link data are recorded in computer memory and persistently maintained.

In a further form of the invention, the following extra steps may then be taken for screen page image(s) display:
8) transmitting via a computer network said screen page image(s) and said interaction(s) area(s) specification(s) from one or more computer systems and displaying said related screen page image(s) on one or more end user computing devices for viewing by end user(s);
9) said end user computing device(s) accepting one or more inputs for interactions by said end user(s) with one or more areas of said screen page image(s) corresponding to one or more said coordinates in said interaction(s) area(s) specification(s);
10) applying one or more special effects to area(s) of a said screen page image, such as area(s) corresponding to one or more said coordinates in response to said end-user interaction(s);
11) acting on said end-user interaction(s) by reference to said link data associated with the said coordinates of the interaction(s), including triggering the processing of said link data;

In an embodiment of the invention, general purpose digital computer(s) may be employed to execute steps 1 to 7 (inclusive), while general purpose digital computer(s) or end-user computing device(s) or both may be employed to execute steps 10 and 11.

It will be appreciated that the action of step 11 may well be for example, to in effect restart the method at step 1 with a new Document based on the said link data of step 11. Alternatively, step 11 may for example in effect restart the method at step 8 if steps 1 to 7 have already been appropriately carried out with their results (or part thereof) persisted separately or stored in the image file (e.g. using a ExlFlmageDescription field in a JPEG file, private TIFF tag, or the Extensible Markup Platform (XMP) ISO 16684-1:2012 to store interaction(s) area(s) specification(s)). That is to say if required image page(s) are already available copies may be made without having to redo them.

In a preferred embodiment (and without limitation) it may be convenient for load balancing purposes to group steps 1 and 2, steps 3 to 5 (inclusive), and steps 6 and 7, to perform these three groups on three general purpose digital computers (or three “server farms” with each farm having one or more of such computers).

In another embodiment, steps 1 to 7 could be implemented on an end user computing device (acting as a “server”) while step 9 could be implemented on another end user computing device (acting as a “client”); with optional step 10 if implemented and step 11, may be performed on either device or both of them (e.g. depending on whether HTML user action events are transmitted from client to server).

In an alternative embodiment, the application of one or more special effects in step 10 may be processed on one or more general purpose digital computers, with result(s) sent via a computer network for display on end-user computing device(s).

In another embodiment, optionally, step 10 above may be omitted from the method altogether where for example, an immediate response to end user interaction is not required.

In a preferred embodiment where step 10 is included, it will be appreciated that without limitation, the above-mentioned special effect(s) could include the showing of one or more translucent overlay(s) upon a portion of writing (or graphic depiction) shown on a screen page image or a border around graphic(s) depicted in screen page image(s). Further or alternatively, a special effect may include presenting options (such as presented by a context menu) related to where the link data is acted upon such as either on the end user's device (such as to fetch a web page) or on a server computer (such as to view different writing and graphic depiction(s) so converted from another Document inputted into an embodiment of the invention).

It will be further appreciated that the link data of the previously described method could be in the forms of URLs.

In a preferred embodiment, shared response(s) to said user interactions (such as special effect(s)) could be applied to one or more of the said special effects areas where the said link data is the same between them. As previously stated, this can occur when said coordinates of a single run of styled hypertext create several said special effects areas because the styled hypertext concerned wraps over several lines of styled text; and including where that styled hypertext does not span the column or such other styled text wrapping boundary in which that styled hypertext lies.

It will also be appreciated that the rasterising of step 6 may be performed before, during and/or after: the identifying any styled hypertext or interactive graphical element(s) having links, the analysing of any said identified styled hypertext or interactive graphical element(s), and the associating of said coordinates (steps 3, 4 and 5). This is because screen page image(s) will usually be required to be rasterised irrespective of whether or not the Document page(s) contain/include styled hypertext and/or interactive graphical element(s)—since users may still be expected to wish to view the information.

It will be appreciated that a pixmap may contain imagery additional to screen page imagery and likewise, interaction(s) area(s) specification(s) may include data additional to that pertaining to screen page images; however the invention does not require any of these to be the case.

Without limitation, the said processing of link data in the previously described system and method could include accessing or managing Content Elements or launching another program or a combination of these. It will be additionally appreciated that the the areas available for paged information display on end-user computing device(s) or program(s) running on those devices may be ascertained by querying those devices/programs or from a list of supported devices/programs or both of these. Likewise, without limitation, the magnification/zoom level that may be a factor in pagination may be ascertained by end user selection made from an end user computing device or from a list of supported levels or both of these.

Optionally, where applicable, an interaction area(s) data may specify static/streaming/dynamically-generated media/applications/widgets/controls as applying to interaction area(s). For example, if the text before a series of blank underline characters (e.g. ASCII code 242) has a string with the word “sign” in it, a signing widget rather than a text control may overlay the place of the underline characters in the presentation of a screen page image to an end user. When the widget is activated, a larger signing panel may then be modally presented. In view of this overlay in the interaction area(s) specification the system may have replaced the underline characters with blank spaces; whenin after the signature is captured the resulting digitised signature may be transmitted back to the server processing means for rasterisation into an updated version of the screen page image, thus securing the signature on the server processing means and transmitting it to the display device means, ensuring everyone is on the same page so to speak. It will be appreciated the system may be informed by Publishers of what string(s) refer to what static/streaming/dynamically generated media/applications/widgets/controls.

Suitable pagination in preferred embodiments may include whitespace reduction or decreasing font sizes (particularly of headings) for viewing on small screen devices, and the reverse of these on large screen devices. Suitable pagination may also include expanding or reducing content elements to fit the page size.

Optionally, as part of pagination, a Graphic Element in Document that is ‘invisible’, indistinguishable from the background, or otherwise expressly marked up or regarded as a placeholder may be used to reserve space for overlaying information to be displayed on an end user computing device. Such placeholders may allow the overlay of a JPEG file to represent a Graphical Element while a PNG file represents styled text in the underlying page image. Such an arrangement may save bandwidth, improve readability, or both. Placeholders may also be used to allow the placement and showing of streaming video or other media linked to or embedded within the Document.

On the other hand, a more secure option may be to merge information into spaces within a page image that is reserved by placeholders, as part of that page image's rasterisation, prior to page image transmission to an end user computing device. This may allow the merging of information external to the Document such as content served up by advertising services, so as to thwart ad-blockers, especially when page image(s) are transmitted over an encrypted data link.

In another scenario, particularly where information is to be presented in a Web browser, Graphic Elements within a Document may often be treated as placeholders (especially if they they cannot be fully displayed) whereby an overlay will allow such graphics to be manipulated, such as by zooming and/or panning.

But such placeholders need not appear on an end-user computing device as blank spaces: They could for example show a reduced representation of the Graphic Element concerned that fits into a page image, together with an interaction area specification, which can activate an overlay containing a full-sized representation that is only downloaded or shown when the place-holding graphic is touched. Such overlaying information when displayed may optionally be shown in a frame that does not conform to the boundaries of its underlying placeholder—such as a picture that is presented for manipulation in a larger container than the page image from which it was selected for example.

Optionally, said end user computing device(s), after receiving copy(s) of pixmap file(s) in conjunction with copy(s) of interaction(s) area(s) specification(s), may themselves be allowed to cache such information for subsequent presentation.

In all cases throughout this specification: The invention's use of rasterisation for screen page image creation, and persistence of those screen page images—ultimately for display on end user computing devices—involves automatically converting Content Elements (e.g styled hypertext or interactive graphical element(s)), as laid out on Document page(s), into one or more pixmaps (i.e screen page image(s), such as expressed as a PNG or JPEG file) in conjunction with specifying related interaction(s) area(s) specification(s). Notably, screen page image(s) and interaction(s) area(s) specification(s) are a representation in a different form of the Publisher's Document(s) and the Content Elements they contain, and not the Document(s) or content element(s) themselves. Once screen page image(s) and interaction(s) area(s) specification(s) have been completed, the invention makes no further use of the Document or the Content Element(s) from which they were made (apart from extracting metadata such as to support any fuzzy bookmarking explained shortly, and extracting any relevant graphical media to support any placeholder overlays).

### BRIEF DESCRIPTION OF THE FIGURES

FIGS. 1 to 17 (inclusive) and 18A to 18C (inclusive) and 19 have been provided to assist in the understanding of the invention and its benefits, by way of examples and illustrations. It is not intended that the Figures in any way limit the operation of the invention to a particular style of implementation of the various possible embodiments, but rather are each provided to illuminate aspects of these. (It will be further appreciated that in the line drawings in FIGS. 14, 16 & 17 and 18A, 18B & 18C and 19, certain aesthetics have been lost in the changing of colour renderings to monochrome line art in this specification).

Turning now to FIG. 1, there is a flow diagram/schematic that may be understood as an overview of an example of the invention.

Further, FIGS. 2 to 5 are flow diagrams explaining how interaction(s) area(s) data may be created from the geometric disposition of any styled hypertext or interactive graphical element(s), relative to page(s) within a Document.

FIG. 6 sets out Hypertext Markup provided by the Internet Assigned Numbers Authority from their example.com web site, that features some styled hypertext.

FIG. 7 shows interaction area data in an example image map code fragment, which an example embodiment of the invention may automatically produce by converting the styled hypertext set out in FIG. 6.

FIG. 8 is an illustration of a screen page image to which the image map code fragment of FIG. 7 relates, which an example embodiment of the invention may likewise automatically produce by converting the hypertext markup set out in FIG. 6.

FIG. 9 is an example of how scanned Documents (or parts thereof) may be processed to make such more suitable for aspects 6, 8 & 10 of FIG. 1 in an example embodiment of the invention.

FIG. 10 illustrates how graphical element(s) are processed in an example embodiment of the invention.

FIG. 11 sets out an example of hypertext markup containing/including styled text, styled hypertext, an interactive graphical element with link data, and an interactive graphical element with link data in the form of an image map.

FIG. 12 illustrates the display of the Hypertext Markup Language (HTML) Content Elements as set out in FIG. 11 within Microsoft Internet Explorer version 11.0.9600.18036.

FIG. 13 illustrates the display of the HTML Content Elements as set out in FIG. 11 within Mozilla Firefox version 41.0.1, that nevertheless in some respects looks different from the same Content Elements wthin Microsoft Internet Explorer shown FIG. 12—even though both were running on the same computer and operating system at the same time and in the same end-user session.

FIG. 14 illustrates a JPEG file that may be part of the output of an example embodiment of the invention corresponding to a rasterization of HTML Content Elements derived from the HTML set out in FIG. 11. That is to say FIG. 14 is an illustration of nothing more than the image encoded in a single pixmap file.

FIG. 15 exemplifies HTML code output of an embodiment of the invention which relates an image map for use in conjunction with the JPEG file of FIG. 14, which HTML code can replace that HTML Content Elements code set out in FIG. 11 to eliminate all styled hypertext.

FIG. 16 illustrates the presentation of the HTML code containing an image map and the related JPEG screen page image outputs of an example embodiment of the invention as shown in FIGS. 14 & 15, using Microsoft Internet Explorer version 11.0.9600.18036.

FIG. 17 illustrates the presentation of the same output of an example embodiment the invention as shown in FIGS. 14 & 15, but using Mozilla Firefox version 41.0.1 instead. The presented information is now exactly the same as that depicted in Microsoft Internet Explorer of FIG. 16—unlike FIG. 13—such that the layout of the information presented in the two example Web browsers is now identical.

FIGS. 18A to 18C illustrate screen page images (displayed in a Web browser) that are possible outcomes of an example embodiment of the invention, that has been converted from the HTML Content Elements set out in FIG. 11—including by being suitably paginated. Each of FIGS. 18A to 18C illustrates a possible automatically created screen page image as a JPEG file displayed in a Firefox Web browser in conjunction with the possible HTML code output produced by an embodiment of the invention; each of which code output contains an image map to support end user interaction with the related JPEG screen page image. Notably, none of the HTML code outputs contains any Content Elements such as styled hypertext.

FIG. 19 illustrates an outcome of an example embodiment of the invention as shown in a multi-column Web browser presentation.

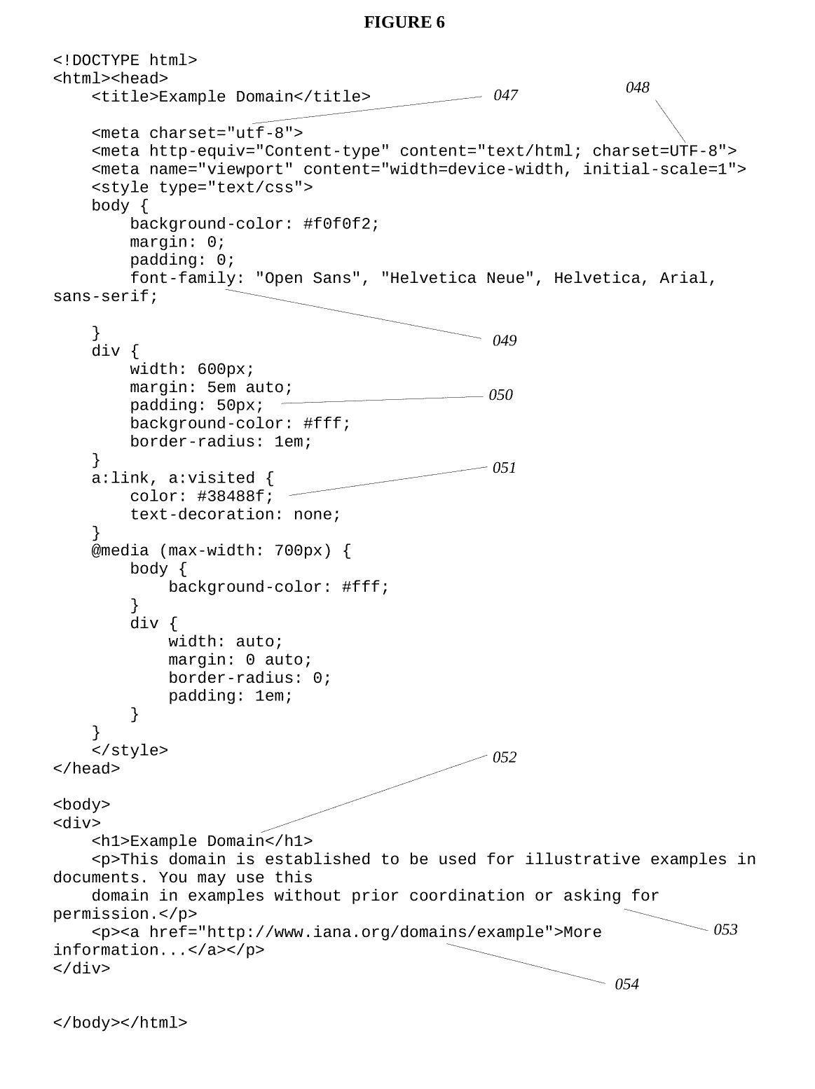

It will be appreciated that FIGS. 6, 8, 11 to 17 (inclusive) and 18A to 18C (inclusive) provide simple examples/illustrations for ease of explanation.

### DETAILED DESCRIPTION

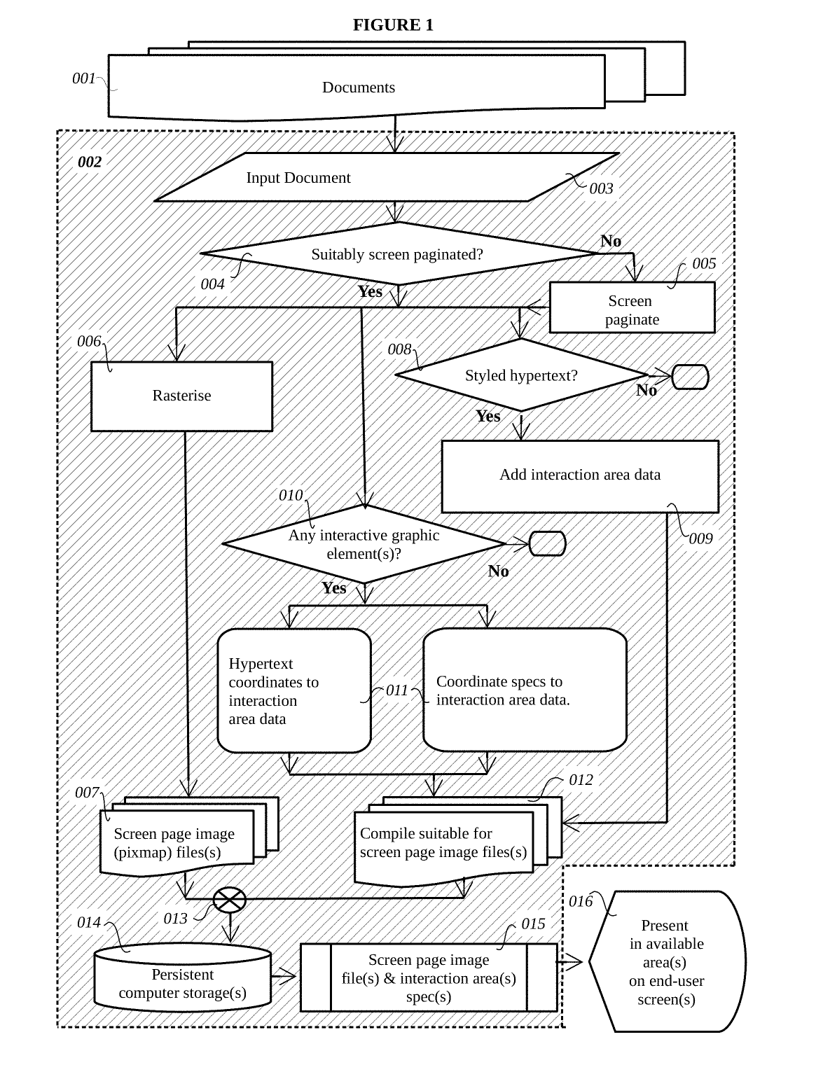

FIG. 1 is an overview of an example embodiment of the invention starting with a Document 001 that is stored in computer memory such as is well-known to the art. Such computer memory may reside within one or more general purpose digital computers which may be networked together to form server computing environment 002 or within end user computing device(s) or network attached storage, as the case may be. In all embodiments of the invention, only the computer systems used by Document 001 Publishers and aspects (such as 004, 005, 006, 008 & 009 of FIG. 1 for example) of the server computing environment 002 need be compatible with or match Publisher encodings and fonts. End user computing devices 016 need not have any character encodings or fonts in particular as far as the invention is concerned:

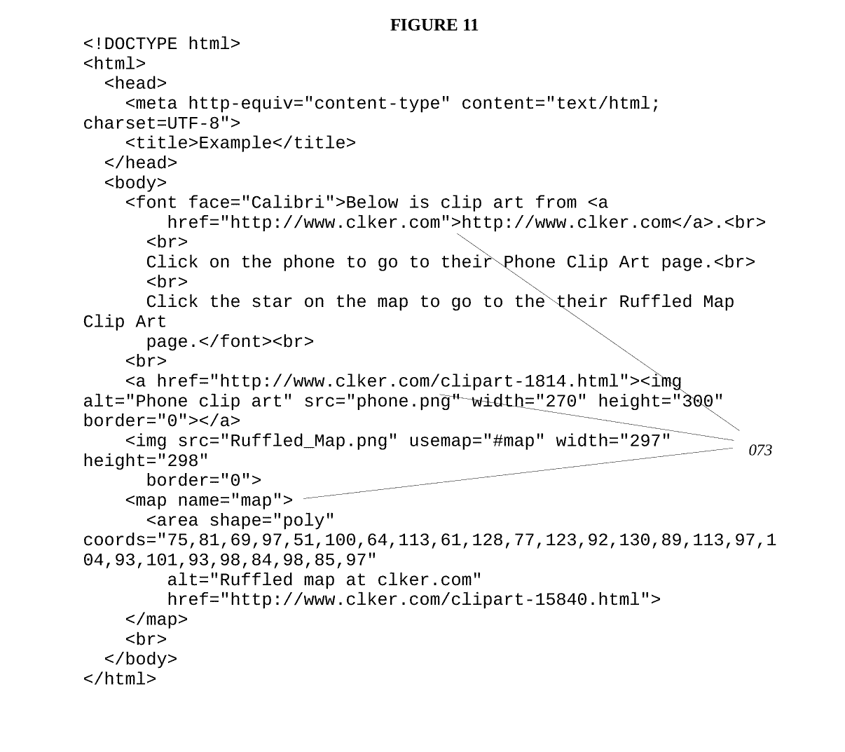

Document 001 containing/including styled hypertext and/or graphical elements with link data may be inputted 003 to computer memory on general purpose digital computer(s) within server computing environment 002. Simple examples of such Documents are set out or depicted in FIG. 6 and FIGS. 11, 12 and 13.

If a Document contains/includes text without any styling, inputting it 003 includes preprocessing so that a default style is applied to convert it onto styled text. If a Document is a PDF Document, inputting it 003 includes preprocessing, to convert it into a form where it can be re-paginated and its Content Elements more easily managed such as into a word processor format, as known to the art.

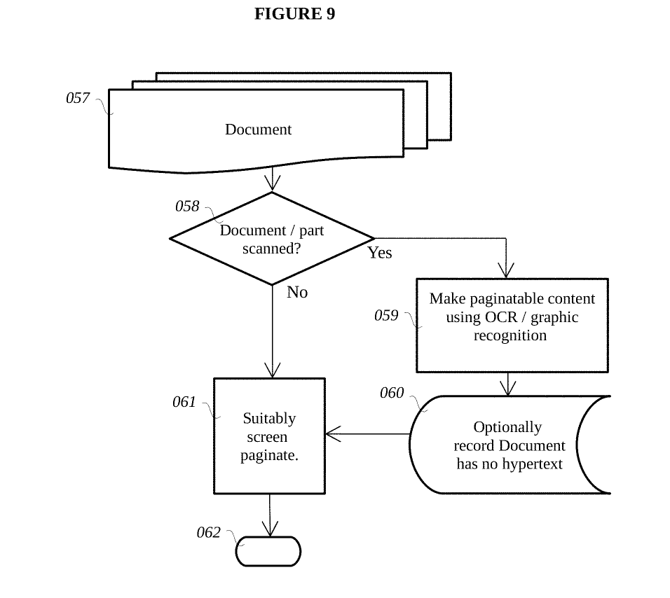

Likewise, if an inputted Document contains scanned page(s), such as a digital version of printed page(s), the Document (or scanned parts thereof) may require optical character recognition (as exemplified in FIG. 9) to convert the scan—e.g. Group4 or JBIG2 images in a PDF “wrapper”—into paginatable Content Elements such as styled text, and styled hypertext (e.g. styled hypertext with URLs both of which are derived from such URLs expressly appearing in the writing on a scanned page). Alternatively, document images may be provided in the form of TIFF files for OCR conversion into Documents containing Content Elements.

In a preferred embodiment, a Document may then be analyzed 004 to see if it is already suitably paginated. Without limitation, suitable pagination for example may be for the showing of screen page image(s) within available display area(s)—which area(s) may be screen column area(s)—on end-user computing device(s) 016. A Document may be suitably paginated 005 using methods known to the art, including paginating one or more sections of a Document at a time. Sections to be paginated could be prioritised by demand, such as those parts of a Document which are new or a section where a user was up to when changed viewing conditions triggered re-pagination.

Suitable pagination may also include recording in persistent memory (such as in a database or text file) a reference (such as a character or picture number) to Content Element(s) appearing on each page. This may allow for example, a user to “Fuzzy Bookmark” information (as discussed shortly).

The Document then may be rasterised into screen page image(s) 006 which are persistently stored (“persisted”) as pixmap files (such as JPEG) in computer memory 007. Each screen page image file 007 may in some embodiments of the invention, have a filename corresponding to the Document's page number(s); for example, a screen page image that is a representation of page 1 of a Document may be called “p1.jpg” or “Section2Page1.jpg” (if the pixmap is stored in a JPEG file format for instance). Regardless of the form of persistence, screen page image(s) usually must be associated with the page number(s) or other reference(s) related to the Document page that was rasterised (including without limitation, so that they may be referenced by any interaction(s) area(s) that represent internal references such as bookmarks). Reference data describing which image page(s) were generated from which Document page(s), may without limitation, be persisted in a database for example.

Such an arrangement may be used for example, to resolve requests from an end user computing device where the end user for example, wishes to sequentially read through or go back through information, image-page-by-image-page (or view multiple image pages at a time in a columnar display).

Reference data describing which image page(s) were generated from which Document page(s), may without limitation, also be used by embodiments of the invention to for example, log the following valuable information:
when a screen page image was sent to or loaded by an end user computing device;
when a screen page image was displayed on an end user computing device;
the time elapsed before another screen page image was displayed on an end user computing device replacing a previous screen page image;

Such logged information may be used to confirm end user access to information, time/track information usage, or to confirm information was displayed on screen for compliance purposes, for example.

Screen page image(s) may also be associated with a reference to Content Element(s) residing in a screen page image's respective corresponding Document page (e.g. “Words1003-1381=Page1”). Which Content Element(s) reference(s) relate to which image page(s), and visa-verse, may be stored in a database or persisted in text file(s) for example.

This arrangement may allow for example, a screen page image when it is viewed on an end user computing device to be Fuzzy Bookmarked by the end user or device for viewing that portion of information using different-sized screen page image(s)—e.g, after a user has switched to a different kind of end user computing device with a different screen size—without loosing their place in the information.

For example, if a screen page image appertains to word number 1003 (appearing at the start the writing in the screen page image) to word number 1381 (appearing at the end of that writing), then a Fuzzy Bookmark for that screen page image may be resolved to a target screen page image from a set of smaller-sized screen page image(s) appertaining to word number 950 to word number 1110—since word number 1003 of the Fuzzy Bookmark falls within that range. Likewise with a set of larger-sized screen page image(s), the image appertaining to word numbers 913 to 1402 would be the range in which the Fuzzy Bookmark “1003” would resolve if that set of screen page image(s) were displayed.

Fuzzy Bookmarking can be used to approximately keep the end user's place in information when a different set of suitably-sized screen page image(s) is requested by an end user computing device due to 740 changed viewing conditions of example. In an end user computing device having a multi-columnar display for example, one or more screen columns with the screen page image in which the information pertaining to the Fuzzy Bookmark appears may be highlighted or otherwise indicated to the end user.

Thus in a three-column display on an end user computing device, if the Fuzzy Bookmark pertains to the middle screen column, that column would be drawn to the end user's attention by momentarily highlighting it for example.

Content element references associated with screen page images (e.g. “PictureAdvertisement1=Section2Page1”) may also be used to resolve requests where for example, a particular part of information is requested by an end user computing device such as when an end user specifies a desired heading, section, paragraph number, or picture for example. A content element reference may also contain, or contain a reference to, any interaction area data corresponding to that content element (e.g.“PictureAdvertisement1,50,50,200,150=Section2Page1”).

The association between content element references and image pages may also be used by embodiments of the invention to for example, log the following valuable information:
when a representation of a particular content element was sent to or loaded by the end user computing device;
when a representation of a particular content element was displayed on an end user computing device;
the time elapsed before another screen page image was displayed on an end user computing device replacing a previous screen page image containing a representation of a particular content element;
if and when a representation of a particular content element was selected by an end user.

The latter point only applies if the representation of the particular content element by the screen page image is accompanied by corresponding interaction area data in an interaction(s) area(s) specification accompanying the relevant screen page image.

Such logged information may be used: to prepare/launch static, streaming or dynamic media/applications/widgets/controls for use where the Content Element representation is a placeholder for such, or track the exposure of content element representations, or trigger action(s) when certain content element representation(s) appear, or how end user(s) interact with certain content element representation(s), for example.

The order in which Document page(s) are rasterised to create screen page image(s) may be sequential or prioritised to suit demand, such as those parts of a Document which are new or screen page image(s) containing the writing and/or graphic representations on screen when changed viewing conditions call for a different set of screen page image(s), or when an end user specifies what part of the information is desired to be displayed. As previously mentioned, the latter may for example, be accomplished with a database of content elements referenced to word numbers that may be associated with page images. By such means matches to search strings may also be found, and their relevant page image(s) returned to an end user computing device.

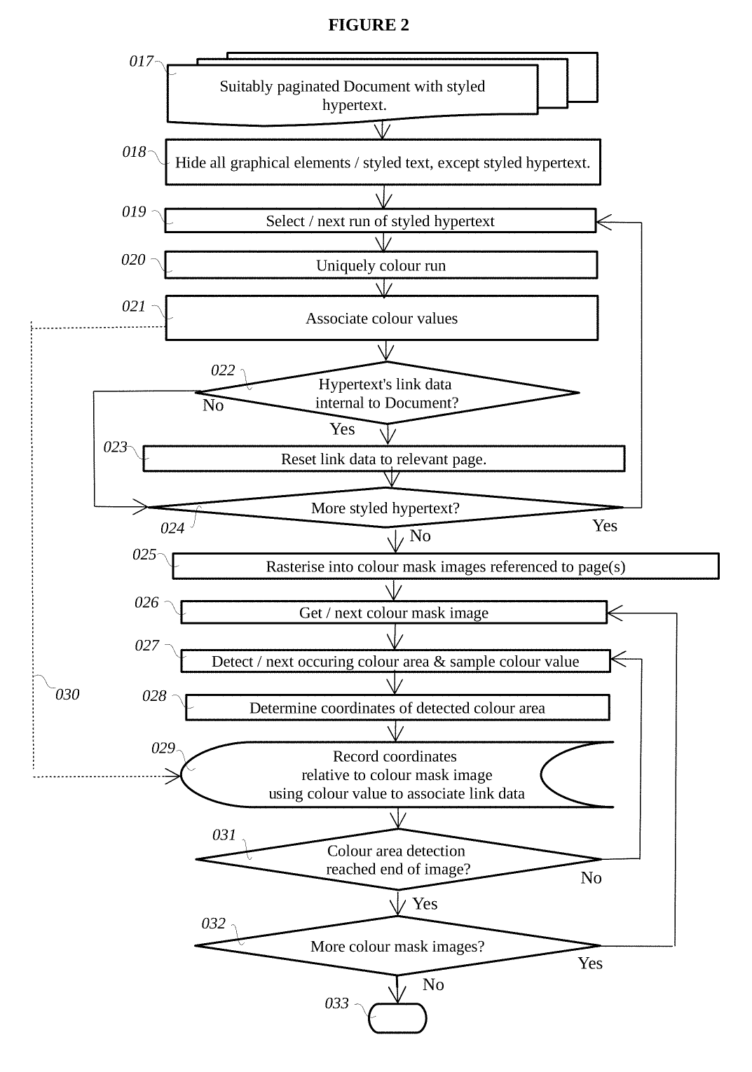

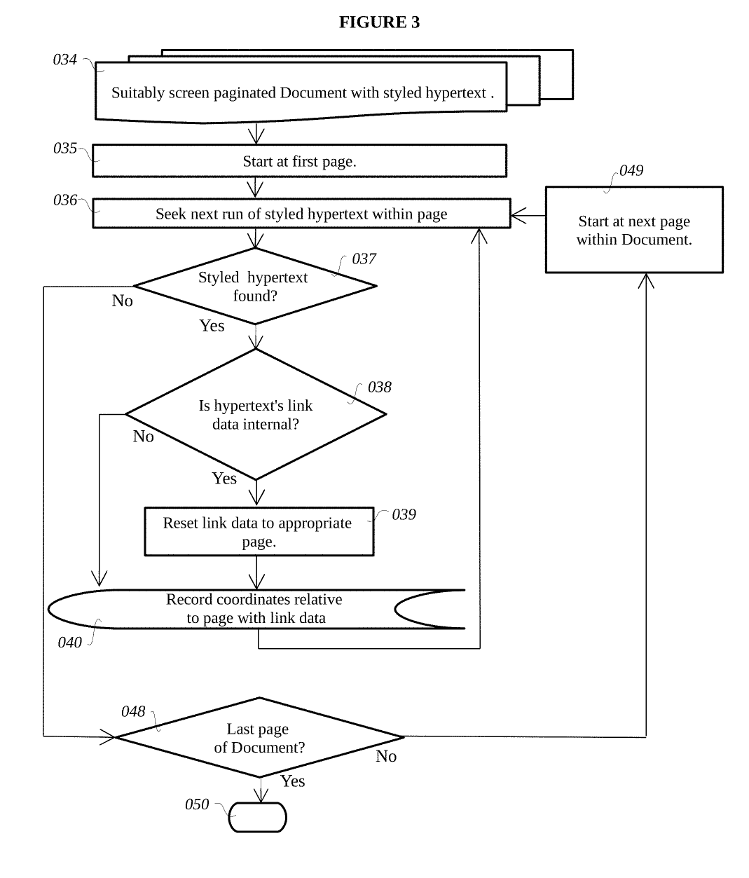

The Document may be analised to determine if it contains any styled hypertext 008, and if styled hypertext is not present in the Document this branch of processing is terminated. Otherwise, the Document is processed 009 so that interaction(s) area(s) are detected corresponding to the geometric disposition of where styled hypertext falls on page(s). The best way to detect such areas may depend on the structure or type of Document that has been inputted (optionally after preprocessing). The invention may (without limitation) employ procedures exemplified by FIGS. 2 to 5 (or a combination thereof) to accomplish this. The procedure exemplified in FIG. 3 may be used for word processor Documents or Web pages for example; the procedure exemplified in FIG. 2 may be used for any other kind of Document for example. An embodiment of the invention may assign pages to such procedures depending on the type of Document being processed.

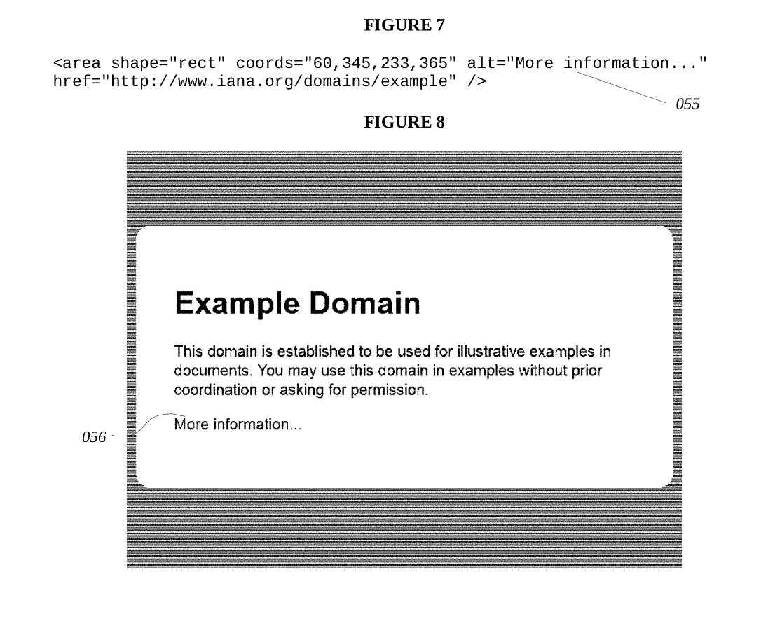

Such detected coordinates of interaction(s) area(s) corresponding to the geometric disposition of styled hypertet on page(s)—with its corresponding link data (which combined forms interaction(s) area(s) data) is stored in computer memory; a simple example of interaction(s) area(s) data created from hypertext may be observed in the image map “shape” code fragment set out in FIG. 7.

Likewise the Document is also analysed to determine if it contains/includes any interactive graphical element(s) 010, which analysis is preferably carried out separately to the aforementioned rasterisation 006 and may also be separate from the previously described styled hypertext interaction area determination(s) 008, 009 & 012.

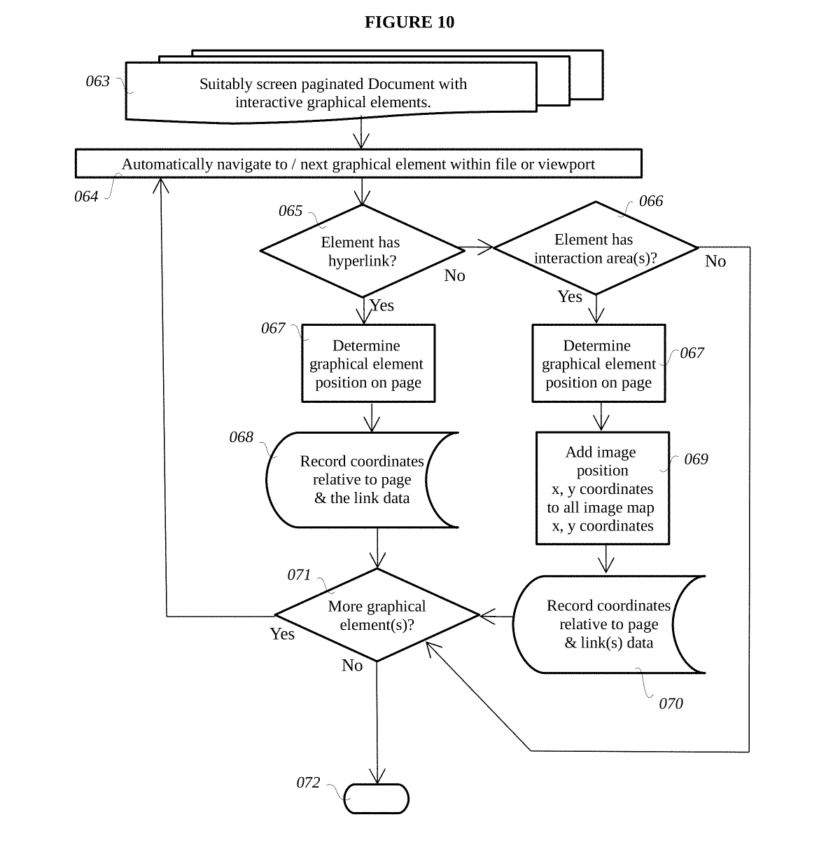

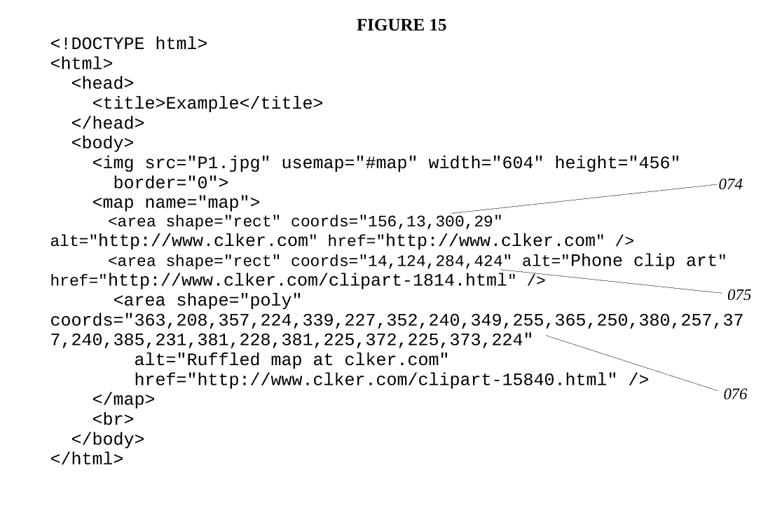

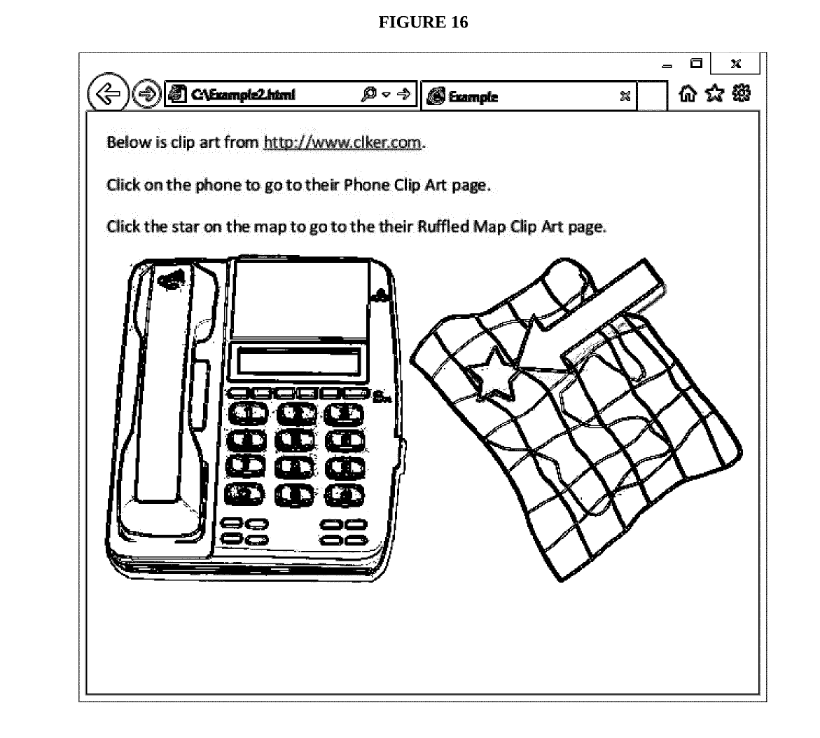

There are two broad types of interactive graphical elements a Document may contain/include: There are those graphical elements where a link or action may be activated by selecting (e.g. clicking or touching) anywhere on the graphical element, and also those graphical elements where portion(s) of the element may be selected to activate link(s)/actions. If the Document contains/includes any such interactive graphical element(s), they are processed 011 so that interaction(s) area(s) data, such as that which could be specified in an image map, are created corresponding to the geometric disposition of where the linked area(s) fall on their respective page(s)—see aspects 74, 75 & 76 of FIG. 15 for example; which interaction area(s) data is recorded in computer memory, according to FIG. 10 for example.

In the case of interactive graphical element(s), the analysis 010 may optionally also determine if a non-standard image map is employed such as may be custom created using JavaScript not in conformance to HTML image map standards. To accomplish this, an embodiment of the invention may use data extraction techniques upon non-standard interaction(s) area(s) specification(s) which may incorporate word matching or pattern recognition of hotspots defined in JavaScript for example, such as produced by particular creation tools or Web sites where the means by which such image maps are specified may be readily observed (e.g. a predictable encoding).

Interaction(s) area(s) specification(s) may be implemented as an image map for example, which image map may contain the source Document's hypertext and/or graphical element link data.

It will be appreciated that the determination of interaction(s) area(s) data in relation to references internal to a Document such as bookmarks, may be dependent on pagination being already completed enough to know on what page(s) the target of internal reference(s) will fall. This may be a problem with very long Documents, which may take many seconds or even minutes to paginate and which will therefore be paginated in sections as is known to the art. In that case image page(s) sought by an end user computing device may be ready to view except the destination of internal references targeting other sections of the Document may not be ascertainable until paginated and therefore missing from the data within resulting interaction(s) area(s) specification—e.g. the target image page to which an already presented interaction area refers may not become known until some time after the interaction area may appear on end user display device(s).

Therefore in preference, embodiments of the invention may include an internal reference (such as bookmark or anchor) conversion delay handler to allow screen page image(s) associated with partially completed interaction(s) area(s) specification(s) to be presented with the incomplete interaction(s) area(s) data being updated when the target screen page image (and any other missing data pertaining to the internal reference) becomes known. This may be achieved by using “server-side” image mapping or server-updateable interaction(s) area(s) data on an end user computing device, such as may be implemented in a Web browser using JavaScript for example.

While the interaction(s) area(s) data is being completed, an end user may be informed by message box or other indication that the link to another image page is still being resolved. The possibility of long Documents causing interaction(s) area(s) data delays means doing pagination 005 or subsequent rasterisation 006, in conjunction with interaction(s) area(s) data determination 008, 009, 010, 011 and specification 012 can be suboptimal at best. In preference therefore the process of determining interaction(s) area(s) data should run independently of pagination and/or rasterisation as shown in FIG. 1.

Any interaction(s) area(s) data corresponding with styled hypertext 009, and any interaction(s) area(s) data ascertained from interactive graphical elements 011, that is related to a particular page, is combined 012 such as to form an interaction(s) area(s) specification(s)—such as an HTML image map—that is related to the screen page image 006/screen page image file 007 of FIG. 1. Moreover embodiments of the invention may employ more than one screen page image file 007 to persist a screen page image 006, which may better suit the transmission of larger screen page images over low capacity, high latency or congested computer networks.

In such cases the screen page image may be displayed on end user computing device(s) in parts as they are received to allow end users to start viewing information before all of a screen page image has been received. Likewise without limitation, a screen page image 006 may have multiple interaction area(s) specifications 012—one for each screen page image file 007 for example—to allow end user interactivity with screen page images that may have only been displayed in part pending transmission of further screen page image file(s) and their interaction area(s) specification(s). Alternatively screen page image files representing part(s) of screen page image(s) may be presented in the end user computing device as one or more screen page images; this may be used to (among other things) to deter the saving of whole page images to enhance information protection.

It will be appreciated that interaction(s) area(s) specification(s) may be required to be created by embodiments of the invention in different forms to allow useful relations with particular screen page image file(s). For example, Apple's Safari Web browser's magnification functions can miss-calibrate image map coordinates provided as HTML. Cascading Style Sheet-based interaction areas are presently limited to overlaying foreground images on a background image, which is not always suitable, and CSS hotspots are also limited to rectangular shapes. In some cases the most workable solution may be for interaction areas to be encoded through Java Script generation and/or an embodiment of the invention may create multiple types of interaction(a) area(s) specification(s) suitable for different end user computing devices (e.g. including their in-built Web browsers) or apps running on those devices.

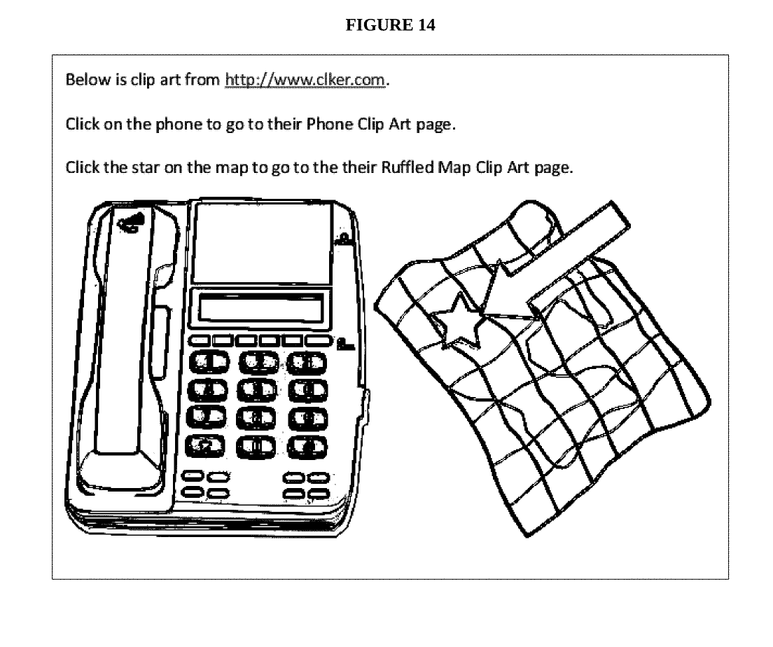

On the other hand, the reference 013 between screen page image files 007 and their interaction areas 012 may be for example expressed in HTML within a <map> tag such as exemplified in FIG. 15 and persisted in a file system(s) 014 of FIG. 1. Screen page image files, such as like that illustrated in FIG. 14, may also be persisted in file system(s) 014. Alternatively, a reference 013 may be achieved by storing a screen page image file with related interaction(s) area(s) specification(s) within a database 014 running on a general-purpose digital computer for example.

In a preferred embodiment, the problems of magnfication/zoom levels of content becoming inconsistent with an image map can be avoided altogether by providing image page(s) that have already at the required magnification/zoom level been paginated and rasterised. This has the advantage of keeping Content Element(s) looking clear and sharp which could otherwise become rough-looking when enlarged, or less readable when reduced.

In another preferred embodiment interaction(s) area(s) specifications corresponding to a particular screen page image file such as a JPEG or TIF file may be combined into that file such as by recording 013 the interaction(s) area(s) specification(s) in an ExlFlmageDescription field or XMP data structure, optionally for persistent storage 014 within the server computing environment 002. Copies could then be requested from or sent by server(s) 015 (such as Web server(s), email server(s) or FTP server(s)) in the server computing environment 002 via computer network(s)—such as the internet—to end-user computing device(s) 016.

In preferred embodiments, such as where the information being presented to an end user comprises a succession of screen page images, the appropriate screen page image file(s) and their interaction area(s) specification(s) could be sent in anticipation of the end user's next request in the sequence, and cached on the end user's computing device. This arrangement may be employed in order to speed up responsiveness to such requests. But the screen repaginated Document itself (and Content Elements therein)—from which screen page image(s) file(s) and interaction area(s) specification(s) were created—need not be transmitted to any end user computing device since it is not displayed (with the aforementioned content element overlays excepted).

End-user computing device(s) may use the JavaScript File API (Application Programmer Interface) for example to programatically extract the interaction(s) area(s) specification(s) from the screen page image file so as to be able to handle end user interaction with the screen page image file, by using the data to help specify, or specify completely, an image map in HTML code such as set out in FIG. 15. Such a novel arrangement has the advantage of keeping screen page image(s) and related interaction(s) area(s) specification(s) together in the same file—saving data transmission costs—and also shifting to end-user computing devices the task of creating image map tags in HTML code for example. Thus interaction(s) area(s) specification(s) embedded in a pixmap could if necessary, be extracted from a pixmap file to be modified by different end user computing devices by those computing devices, for example. The arrangement has the advantage of being portable, by keeping interaction(s) area(s) specification(s) together with page image(s) data.

It is also possible that the resulting pixmap file(s) (such as PNG, JPEG or TIFF) from rasterization may be persisted in such a way as to contain more than one screen page image per file. This may be achieved by employing suitable spacing between screen page images and/or recording dimensions (such as page heights) of each page in a database, file, filename or as ExlFlmageDescription data, and the like. In such cases, interaction(s) area(s) coordinates may be calculated to be referenced relative to the pixmap containing all the screen page images instead of screen page images themselves. Such an arrangement may be convenient for more efficiently transmitting copies of multiple screen page images such as to a Web browser by reducing the number of data transfers between them.

For example, a pixmap file might contain one screen page image vertically below another, copies of which may be loaded and scrolled on end user computing device(s); then depending on he implementation, vertical coordinates may need to be made relative to the pixmap and not the screen page image currently in view—particularly if the screen page image is to be presented using a Web browser without any JavaScript (e.g. by using page-down/page-up keys). Such coordinate adjustment may be performed at the establishment of relationships between screen page image file(s) and their image map(s), or at any time after the relevant interaction(s) area(s) data's coordinates plus the layout of screen page image(s) within the resulting pixmap file(s), is known. Thus for example, the reference 013 between screen page image file(s) 007 and interaction(s) area(s) specifications(s) 012 would also involve the adjustment of interaction(s) area(s) coordinates if more than one screen page image is contained in the image file.

It will be appreciated that interaction(s) area(s) specification creation and Document page rasterisation may be performed one page(s) or Document at a time, or preferably completely independently of one another; so long as interaction area specification(s) are correctly associated with their screen page image(s) corresponding to where styled hypertext or interactive graphical element(s) fall on page(s) in the Document.

It will also be appreciated that interaction(s) area(s) specification(s) and related screen page image(s) could be persisted in multiple ways such as a combination of file system(s), database(s) and file(s) in computer storage.

Copies of screen page image(s) in screen page image file(s) are displayed on end-user computing devise(s) 016 that are also supplied with copies of one or more suitable interaction area specification(s) from one or more computer servers 015 via a computer network.

Optionally, end-user computing device(s) may also create special effect(s) over area(s) defined on an image page. For example, if an area within interaction(s) area(s) coordinates has been selected, and/or when such area is “hovered” over using a mouse for example, end user(s) may be provided with feedback indicating that link data exists and/or that link(s) have previously been navigated, so as to behave similarly to ordinary Web pages. Such special effects may without limitation, include highlighting an area with a colour change or a border in the case of hovering, or making an area darker in the case of previously selected areas for example.

Such special effect(s) could (without limitation) be achieved by optionally overlaying pixmap(s) (with or without alpha channel(s)) upon the screen page image file, which (without limitation) overlay pixmap(s)/alpha channel(s) may be positioned by referencing an interaction(s) area(s) specification and applied for example, with a level of opaqueness. Alternatively, bits of the screen page image file loaded into a Web browser's HTML5 canvas for example, may be manipulated directly with changes to colour values within the interaction(s) area(s). Other ways of creating special effects, such as (without limitation) by drawing lines or polygons, might also be applied to create a special effect as user feedback.

In view of the above, an embodiment of the invention may employ one or more of various ways of detecting the geometric disposition of styled hypertext relative to a page in a Document. FIGS. 2 to 17 (inclusive) and 18A to 18C (inclusive) demonstrate this (by way of non-limiting examples) with respect to converting HTML Document Content Elements into screen page image files in conjunction with interactions areas specifications; which output (without limitation by way of example) is mainly in the form of JPEG files, and image maps expressed as HTML code, for presenting information in a Web browser:

FIG. 2 exemplifies scanning rasterised areas of colour that were created by filling areas of styled hypertext. A suitably paginated styled hypertext Document 017 is modified by changing all the styled text and graphics elements to be the same colour as the Document's background colour (e.g. Document background colour or transparent) 018, except for the styled hypertext (i.e. everything but styled hypertext disappears so-to-speak). The styled hypertext and its character's background-colour(s) are selected 019 and uniquely coloured 020 (e.g. using readily distinguishable RGB values different to the page's background colour) to create areas of different colours corresponding to where each of the runs of styled hypertext falls on page(s). This creates a mask of different colours covering each and every region on a page, on each page where styled hypertext occurs within a Document or section of a Document. Alternatively, the same unique colouring of each run of styled hypertext could be carried out on a character-by-character basis from beginning to end of a Document/section to detect runs of styled hypertext.

An association is made between each run of styled hypertext's link data and the colour value of the styled hypertext, which is recorded in computer memory using any suitable data structure 021. If the styled hypertext's link data references another part of the same Document (e.g. a bookmark) 022 then the data is reset 023 to reference the page number (if it does not already) in which the styled hypertext's target Content Elements appears (which page number is related to their rasterised screen page image(s) number as previously discussed). The creation of such page number referencing is often necessarily because the Document is subject to rasterisation into separate screen page images, whereas Web page or word-processor Document bookmarks for example, are often located by reference to styled text constructs such as paragraphs, words or characters, or HTML tags, that are independent of any pagination.

The process of unique coulorization of each run of styled hypertext on a page continues until all the styled hypertext has been turned into areas of different colours 024 (hereafter “colour areas”). Those page(s) containing colour areas are then rasterised to create colour mask image(s) 025 and referenced by page number (e.g using filenames or database records) corresponding to the Document's page number(s). However, it will be appreciated that such raterisation could also occur as the styled hypertext on each page is converted into colour areas, on a page by page basis for example. It will be appreciated that if a page contains no colour area, no colour mask image is produced corresponding to that page.

After page(s) of colour-area(s) have been rasterised the resulting colour mask screen page image(s) 026 are scanned such as once every five pixels across the image (if the styled textflow be horizontal), and such as in lines five pixels down the image (e.g. creating a matrix small enough to detect any colour area), until a pixel returns a colour value 027 other than the background colour. When such a colour value pixel is found, adjacent pixels are tested and this continues for each colour pixel found of that same value, while keeping record in memory of the outer locations of those colour pixels until no adjacent pixel returns the same colour value; thus the bounds of each colour area may be established 028. Coordinates as pixel values of detected colour areas relative to the colour mask image in which they occur may then be persisted in computer memory 029 with the colour value (such as RGB) associated with each of the hypertext's link data 030 for future reference.

Colour area detection, boundary determination in coordinates relative to colour mask image(s), and record keeping regarding corresponding Document pages, continues until all the colour areas 031 on each colour mask image 032 have been accounted for. The procedure completes 033 when there are no more colour mask images and colour areas from which to determine hypertext coordinates.

The novel approach of using colour areas has the advantage of producing accurate results because coordinates can be determined using colour mask rasterisation 025 which corresponds in dimensions to the raterisation of Document page(s) to create screen page image(s) 006—since the same rasterisation engine may be able to be employed for both purposes. However, in fixed page formats such as with older word processor files for example, this may not be optimal, since such formats may already contain hypertext coordinate information relative to the page. If so, these coordinates could be more efficiently extracted before being suitably converted to interaction(s) area(s) specification(s) suitable for end-user computing devices, and which may also include coordinates pertaining to interactive graphical elements 011.

In relation to such Document(s) with fixed page size(s), a procedure of obtaining the coordinates of any styled hypertext relative to each page is exemplified in FIG. 3. This involves a similar procedure to that exemplified in FIG. 2 only with fewer steps due to the coordinates already being known relative to each page on which styled hypertext appears:

A suitably paginated styled hypertext Document 034 may be parsed starting at the first page for example 035. The next occurrence of styled hypertext is sought 036 (by testing attributes associated with characters for example) and if found on the page 037 a check is performed 038 to see if link data of the found styled hypertext points to another location within the same Document such as in a bookmark. If so, on many occasions the data will already reference the appropriate page, however the data is reset 039 to reference the page number if it does not do so already, which number refers to the Document page in which the styled hypertext's target Content Element(s) appears. Coordinates such as pixel values relative to the page are then persisted in computer memory and associated with the hypertext's link data 040 for future reference. Then the procedure starts over as the next occurrence of styled hypertext is sought 036.

If however, no more styled hypertext is detected 037 on the page, then it is ascertained 048 if the present page is the last page in the Document and if not, the next page is referenced 049 and the styled hypertext coordinate and linked data procedure 036 to 040 starts again. If on the other hand it is ascertained 048 that the last page has been done, then the procedure ends 050.

It will be appreciated that word processor files may contain some pages as page Content Elements and some as scanned pages from printed matter within the same Document. In that case, a procedure akin to that exemplified in FIGS. 9 and 2 may be employed for the scanned pages, while a procedure akin to that exemplified in FIG. 3 may be employed for the Content Elements pages.

Of course coordinates describing the geometric disposition of styled hypertext relative to the page(s) on which it falls are often not readily available; such as in most word processor files where page sizes may only be ascertained in relation to an installed printer driver for example, or Web pages of no fixed page size which only “end” when all Content Elements have been downloaded and laid out and optionally style(s) applied, in an end user computing device.

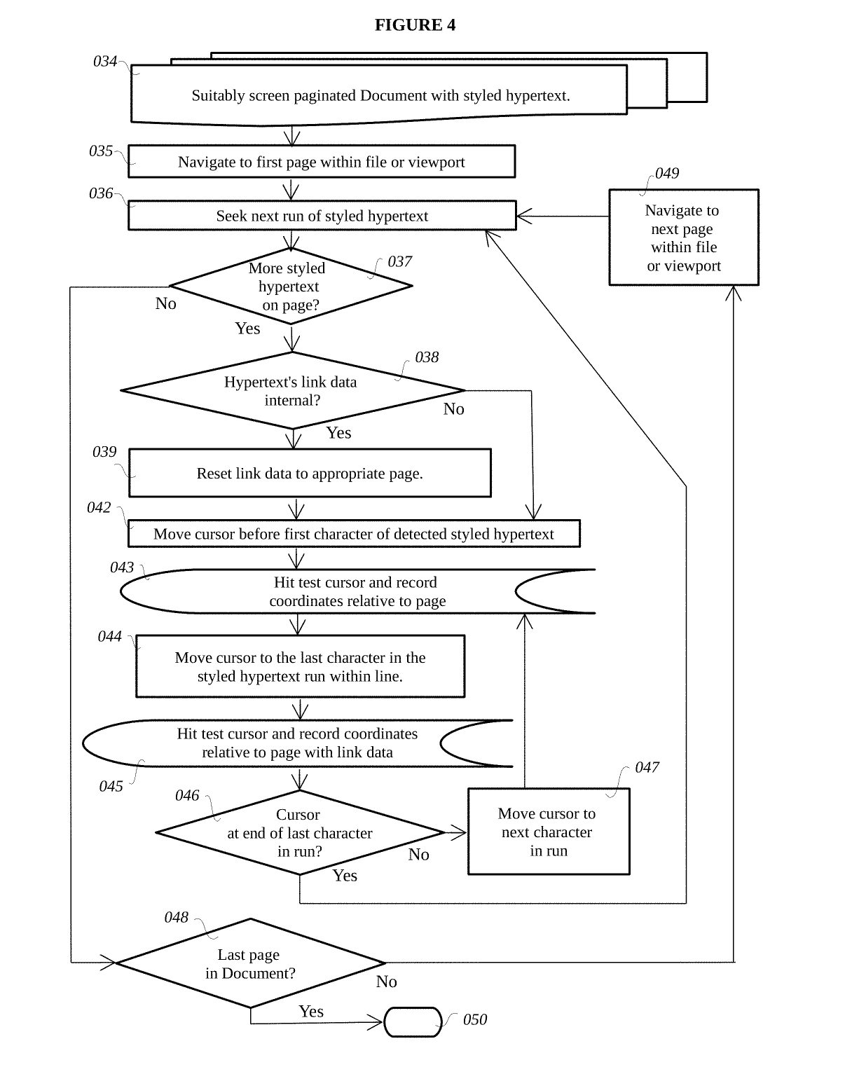

Additionally, calculating the geometric disposition of styled hypertext on a page using font dimensions and layout information although possible, can be a very complex and computationally expensive task—involving variable font widths, kerning, line spacing and the like. In such cases the example procedure diagrammed in FIG. 4 may be employed instead. This uses substantially the same techniques as FIG. 3 as shown in example diagram components 034 to 039 (inclusive) and 048 to 050 (inclusive).

A main difference between FIGS. 2 and 3 compared with FIG. 4, is that FIG. 4 teaches that coordinates of styled hypertext may be alternatively obtained by moving/setting a cursor (as is common to the art in word processors and Web browsers for example) under program control to the start of a run of styled hypertext 042 (by character number for example); which cursor is then hit tested to get the location at which the styled hypertext starts 043 on that page. (Detecting if a run of styled text is styled hypertext may involve testing each character on a page to check if it has any associated link data.) A cursor is then moved/set under program control to the last part of that run of styled hypertext on the line 044, which is hit tested again and the coordinates of the top of the beginning and base of the end of the hypertext on the line are recorded in computer memory along with their associated link data 045. It will be appreciated that in order to determine these values, such as for the vertical axis, it may be necessary to ascertain the height of the line of styled hypertext and take this into account when determining such coordinates. Likewise for the horizontal axis if the styled texflow is vertical.

Whether or not the styled hypertext flows to the next line is then determined 046. This may be done such as by testing to see if the last styled hypertext character detected is at the end of the line and if so, a test is performed to check if there is any data associated with the character at the start of the next line and if so, is it the same link data? If all three of these conditions are met in the affirmative then the procedure for determining styled hypertext coordinates 043 to 046 (inclusive) is repeated. If the three conditions are not met then the next run of styled hypertext is sought 036. Alternatively, if the end cursor position of styled hypertext on the line is located after the last character of the styled hypertext 046 (i.e. there is no more styled hypertext in that run) then the next run of styled hypertext is sought 036; or else the procedure for determining styled hypertext coordinates 043 to 046 (inclusive) is repeated 047 to ascertain coordinates of the continuation of that styled hypertext occurring on the next line.

However in some cases a Document's data structure will permit line-by-line parsing of styled text in a laid out page making the testing of whether or not a cursor is at the end of the run of styled hypertext 046 in FIG. 4 somewhat redundant; so that after hit testing the cursor (under program control) at the end of the styled hypertext on a line and recording in computer memory the coordinates relative to page plus the associated link data, the next run of styled hypertext sought 036 is taken to possibly start on the first character of the next line of styled text. Such optional optimisation may be advantageous for performance reasons.

Similarly to the examples shown in FIGS. 2 and 3, determination of the geometric disposition of styled hypertext in FIG. 4 as coordinates relative to the page and recording in computer memory with associated hypertext data continues until styled hypertext on each page 037 and regarding every page 048 have been accounted for. This may involve scrolling or calling the graphic into an application viewport 049 to enable portions of the Document to be hit tested. The procedure completes 050 when there is no more styled hypertext from which to determine hypertext coordinates.

An advantage of the technique of programatically using cursors (on screen or in memory) as exemplified in FIG. 4, is that it can be faster than the pixel scanning of FIG. 2 for situations where such known styled hypertext coordinates as relied on in the example of FIG. 3 are unavailable. A disadvantage is that relying on hit testing can introduce inaccuracies or variations due to differences in the way Documents might be imaged in computer memory with cursors in comparison to them being rasterised into persistent screen page image(s) file(s). Variations can be more of a problem on some computer systems than others, so in such cases the pixel scanning technique exemplified in FIG. 2 may be more appropriate.

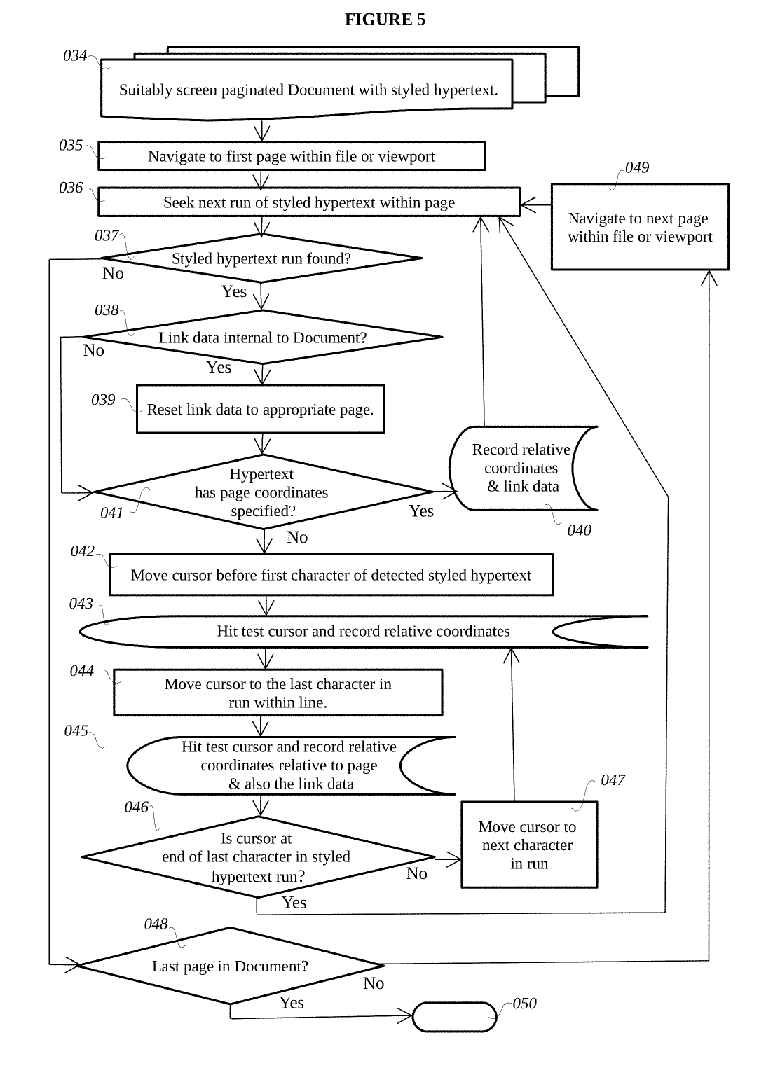

FIG. 5 shows one possible example of where Documents having fixed page size(s) and Documents allowing varying paginations (i.e. page sizes can be specified) can have their styled hypertext dealt with in the same procedure. It will be appreciated that this example shown in FIG. 5 is not meant to limit the possible combinations of the techniques described in the explanations of FIGS. 2 to 4 but rather illustrate a way of how such techniques may be integrated together.

The example procedure diagrammed in FIG. 5 uses substantially the same techniques as FIG. 3 as shown in example diagram components 034 to 040 (inclusive) and 048 to 050 (inclusive). It also employs substantially the same techniques as FIG. 4 as shown in example diagram components 042 to 047 (inclusive). After styled hypertext is detected 037 and any internal link data handled per aspects 038 & 039, a main difference from the previous FIGS. 2, 3 & 4, is that the availability of coordinates of the detected styled hypertext is tested 041, which coordinates are used if available 040. If coordinates are not readily available their determination using cursors commences 042. However as previously mentioned, it will be appreciated an alternative way of determining the coordinates as exemplified in FIG. 2 might also be used.

FIG. 6 shows a simple example of a Document 001 (such as is referred to in FIG. 1). It contains no pagination information and so has no styled hypertext coordinate information relative to the page. Therefore this kind of Document (e.g. after being paginated as a single page) might be suitably provided to the procedures shown in FIGS. 2, 4 & 5, or converted into a fixed page format to be suitably provided to the procedure shown in FIG. 3.

FIG. 7 shows an example of an HTML code fragment specifying coordinates and link data of an interactive area (i.e. interactive area data). In this particular instance the Area Shape tag (which would form part of a standard HTML image map) contains coordinates (“coords”) and link data that was converted from the styled hypertext of the example Document set out in FIG. 6, when paginated in the manner indicated by the line drawing of FIG. 8; which line drawing depicts a rasterized image of the example Document set out in FIG. 6.

It is notable that the example link data of FIG. 7 appearing after the “coords” optionally includes alternative text 055 that an embodiment of the invention has converted from the text of the styled hypertext source code. The value of “coords” in FIG. 7 (i.e. “60, 345, 233, 365”) are coordinates in pixels of the left top-most and right bottom-most parts of the “More information . . . ” 056 writing in the raterised pixmap depiction of FIG. 8. These two coordinates define a rectangle (e.g. at top-left and bottom right corners) which can be incorporated into an image map to allow actions to be selected by end users. In this way, the example HTML Document's styled hypertext may be transformed by the invention's automatic creation of an image map in conjunction with PNG or JPEG file(s) (for example), so as to simulate the Document's behavior as Web page yet without any styled hypertext.

Indeed, one possible hybrid example is to upon an end-user computing device mouse click event, hit test a colour mask aspect of an interaction(s) area(s) specification at the coordinates of that click, to thereby obtain the relevant link data that was associated with the colour value returned. This avoids scanning the colour mask to obtain a list of coordinates, reducing server-side processing.

Thus it will be appreciated that the invention is not limited to simple HTML-based implementations such as the HTML code fragment exemplified in FIG. 7. Moreover by way of example, clicking on a screen page image in a browser with related coordinates pertaining to some writing in that screen page image as set out in an interaction(s) area(s) specification, may trigger a context menu containing dynamically generated options for an end-user to choose from. Such could ascertain if a user wants a Document (referred to by link data or action identifier or both) to for example, be presented using an embodiment of the invention, or opened in a standard browser window, or sent to another application (or frame) in which Content Elements can be viewed or edited.

An example of link data with action identifier could be: “http://example.com///InWebBrowser”

It will be further appreciated that the invention is not limited to any HTML-based implementation(s) such as the HTML code fragment exemplified in FIG. 7, or more sophisticated implementation(s) using JavaScript. For example, similar techniques could be employed within end-user computing device app(s) dedicated to the purpose, which can be made more secure and can better operate offline. The disadvantage of end-user computing device app(s) is that they require prior installation by end users or original equipment manufacturers whereas Web browsers come standard.

FIG. 9 shows how an embodiment of the invention may optionally relate to aspects 003, 004 & 005 of FIG. 1 to handle Documents or parts of Documents that are scanned pixmaps 057. This may be necessary if such Document scans are to be converted into Content Elements such as paginatable styled text; with any express references in writing such as URLs or phone numbers, converted into appropriate link data. In order to accomplish this, the Document is checked for any scanned pages 058 and if any are found, optical character recognition (OCR) may be applied.

OCR 059 also includes recognising written URLs and phone numbers and converting these into styled hypertext by associating link data corresponding to such written references. If no such express references are found then optionally this is recorded in computer memory 060 so that the procedures of FIGS. 2 to 5 can be avoided. Regardless, in a preferred embodiment the resulting Document Content Elements may be suitably paginated, such as to fit within viewing areas 061 for example. The end of the procedure 062 may lead into the rasterisation, interactive graphical element and styled hypertext aspects 006, 008 and 010 of FIG. 1.

FIG. 10 pertains to how interactive graphical element(s) are treated by an embodiment of the invention by expanding on graphical element handling aspects 010 & 011 exemplified in FIG. 1. A Document containing/including graphical elements 063 is automatically navigated 064 for example by referencing a Document object model or by selecting the next picture within the Document. The latter may involve progamatic scrolling or calling the graphic into an application viewport. The graphical element is then tested 065 to see if it has any link data such as a hyperlink. If so, the position of the interactive graphical element on the page is determined 067 such as (without limitation) by hit testing a cursor position or by accessing the Document page's layout data.

For example, the top left position of the graphical element may be first established and then other coordinates may be ascertained by reference to the height and width of the graphical element added to the top left coordinates: If for example, the graphical element within a suitably paginated Document is located 10 units (such as pixels) from the left edge of the page and 10 units from the top of the page, and is 50 units wide and 100 units high, the result obtained after processing the graphical element would be “10,10,60,110” being the top left and bottom right coordinates of a rectangular area. After determination, the coordinates may be recorded in computer memory 068 for combining into a persistent image map, or other type of interaction(s) area(s) specification (see FIG. 1 component 012 for example). Optionally, adaptor code may be required for particular Web sites or image map tools, which may implement interaction(s) area(s) coordinates in Java Script or relating them to Cascading Style Sheets (CSS).

If the graphical element test 065 determines that the graphical element is not associated with link data relating only to the entire element, the graphical element or the page to which it belongs is further tested 066 to see if there is any image map relating to that graphical element. If there is, the position of the graphical element relative to the page is determined 067; but if there is no link data associated with the graphic at all, the next graphical element is automatically navigated to 064 for consideration (provided the last graphic has not already been reached 071). It will be appreciated however that the testing for the type of interactive graphical element does not need to be conducted in any particular order—e.g. testing for interactive graphical elements associated with image maps may be conducted before testing for a hyperlink only.

Previously mentioned adaptation(s) may also be required for interaction(s) area(s) data creation if for example, interaction(s) area(s) are encoded in JavaScript with link data associated with Salable Vector Graphic (SVG) files, or where the interaction(s) area(s) specification(s) is to be implemented in relation to CSS.

The image map/interaction(s) area(s) coordinates are then adjusted 069 by adding to them the corresponding coordinates of the interactive graphical element relative to the page, to produce coordinate data that is relative to the page. For example, if the image associated with an image map was located within a suitably paginated Document 10 units (such as pixels) from the left edge of the page and 100 units down from the top of the page, and the image map data specifies a triangle at coordinates “1,1,11,100,50,50” a result of processing coordinates relative to the page would be “11,101,21,200,60,150”. Such modified image map data now relative to the page may be persisted in computer memory 070 by incorporating it into an image map or other interaction(s) area(s) specification (see FIG. 1 component 012 for example).

After each recording in computer memory of the coordinates relative to the page 068 & 070 the Document is checked 071 to see if there are any remaining graphical elements yet to be navigated. If so, the next graphical element is automatically navigated 064. Otherwise the procedure completes 072.

Bearing the above in mind, the following describes the effect of an embodiment of the invention utilising simple inputs for ease of explanation:

FIG. 11 is a printout of example HTML Content Elements code which contains or refers to styled hypertext, a linked picture, and another picture with image map defining a polygon hotspot 073. Without limitation, this Document, is an example of a type suitable for the aspect 001 of embodiments of the invention shown in FIG. 1.

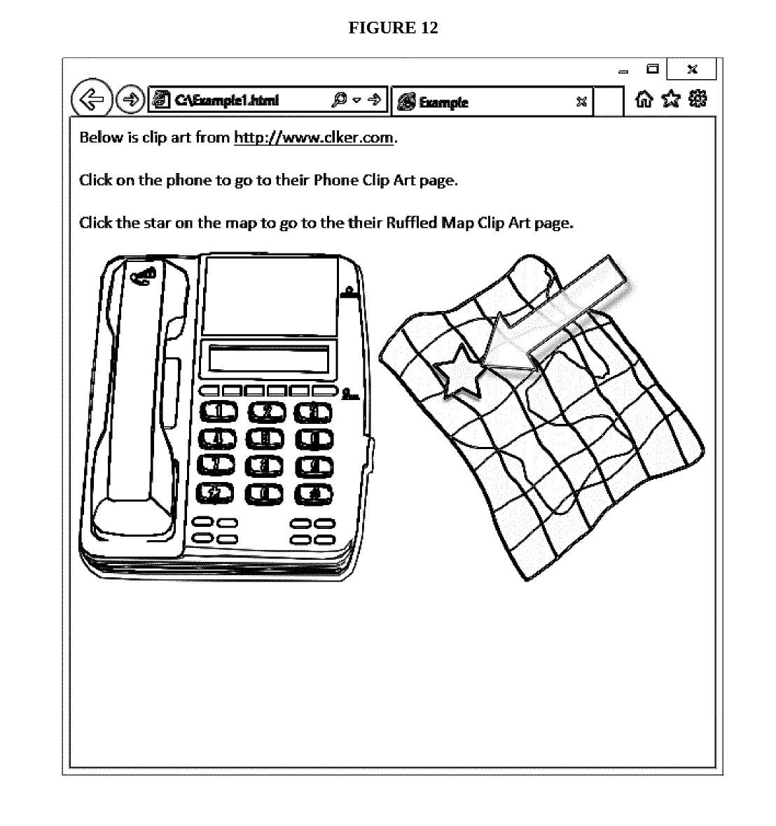

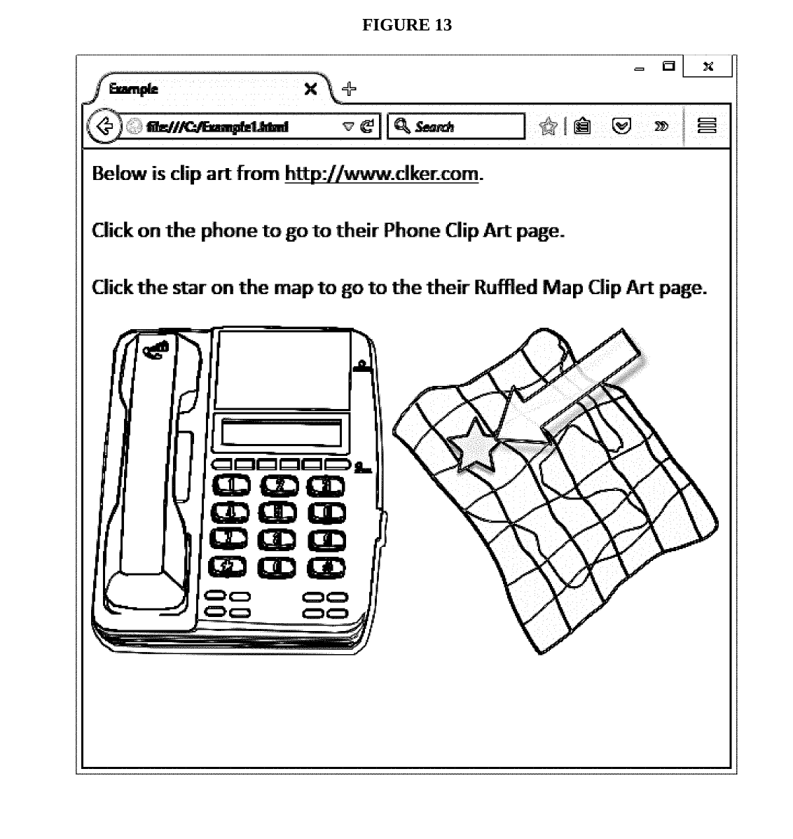

FIGS. 12 and 13 illustrate how different Web browsers (in this case Firefox and Internet Explorer), even when run on the same end user computing device, can display FIG. 11's HTML Content Elements (including referenced images) somewhat differently, as previously described.

FIG. 14 illustrates what an embodiment of the invention's screen page image rasterisation into a JPEG file may look like after conversion from FIG. 11's HTML Document Content Elements. The writing “http://clkr.com” in the JPEG file portrays an image portion converted from the styled hypertext “http://clkr.com”of the inputted HTML Document Content Elements of FIG. 11, which links to http://clkr.com. The depiction of a telephone in the JPEG file illustrates an image portion converted from the phone. png picture referenced in the HTML Document Content Elements of FIG. 11. The depiction of a treasure map with a star and arrow illustrates an image portion converted from the Ruffled_Map . png picture referenced in the HTML Document Content Elements of FIG. 11. (That HTML Document's image map of FIG. 11 defines a polygon hot spot in the star's shape that is relative to the Ruffled_Map.png picture.)

FIG. 15 is a printout of HTML code that may be automatically produced by an embodiment of the invention, which code references the JPEG screen page image file as illustrated in FIG. 14. The HTML code of FIG. 15 also contains an image map with link data which may be automaticaly produced by an embodiment of the invention, that is not the same as the previously mentioned image map of the HTML Document of FIG. 11. It can be seen the new image map in FIG. 15 incorporates the link data derived from the “http://clkr.com” hypertext shown in FIG. 11, but references coordinates 074 relative to the JPEG screen page image file as depicted in FIG. 14. The new image map in FIG. 15 also incorporates the link data derived from the phone. png reference shown in FIG. 11, but with coordinates 075 relative to the JPEG image file as depicted in FIG. 14. The new image map in FIG. 15 additionally incorporates the link data derived from the Ruffled_Map . png reference shown in FIG. 11, but with polygon coordinates in the shape of a star converted to be relative to the star portion 076 of the JPEG screen page image file as depicted in FIG. 14. This is instead of being relative to the Ruffled_Map.png graphical element from which the screen page image was (in part) converted. So unlike the Document Content Elements of FIG. 11, the HTML code set out in FIG. 15 is totally free of character encodings and font information because the effect of graphical elements with link data has been transformed to be part of a pixmap in conjunction with an image map, for example.

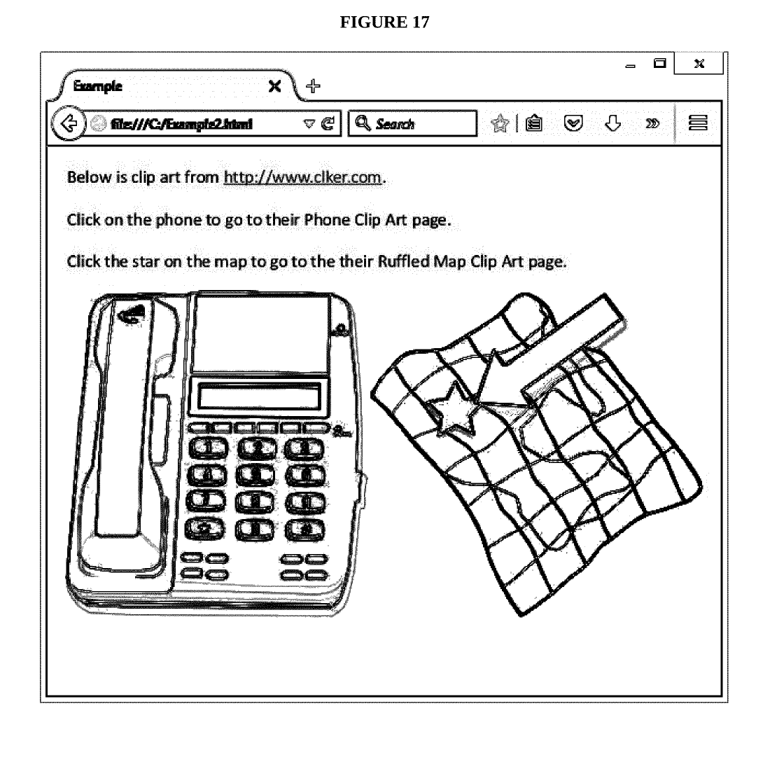

FIGS. 16 and 17 are illustrations of the automatically produced JPEG screen page image file as illustrated in FIG. 14 combined with the HTML set out in FIG. 15, when displayed in the Firefox and Internet Explorer Web browsers respectively. Clicking on the underlined writing depicted therein, the phone illustration or the star on the map, invokes the same URLs as clicking on the corresponding Content Elements illustrated in FIGS. 13 and 14. However unlike FIGS. 13 and 14, as example outcomes of embodiments of the invention the presentation information illustrated in FIGS. 16 and 17 is identical between Web browsers, with the longtime problems associated with styled hypertext and the rasterisation of graphics with link data being solved, without loss of end user computing device compatibility. Thus with known rasterisation, consistently fitting pagination can be accurately supported for display on many different end user computing devices, without sacrificing hyper-linked interactivity intended by Document Publishers.

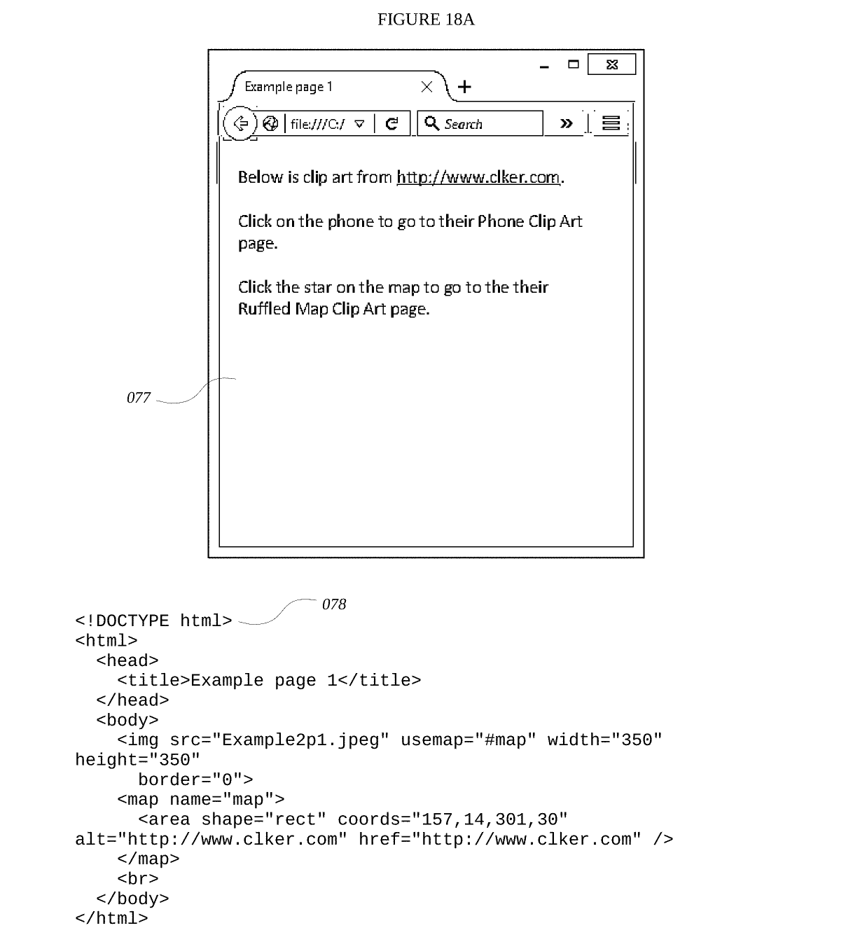

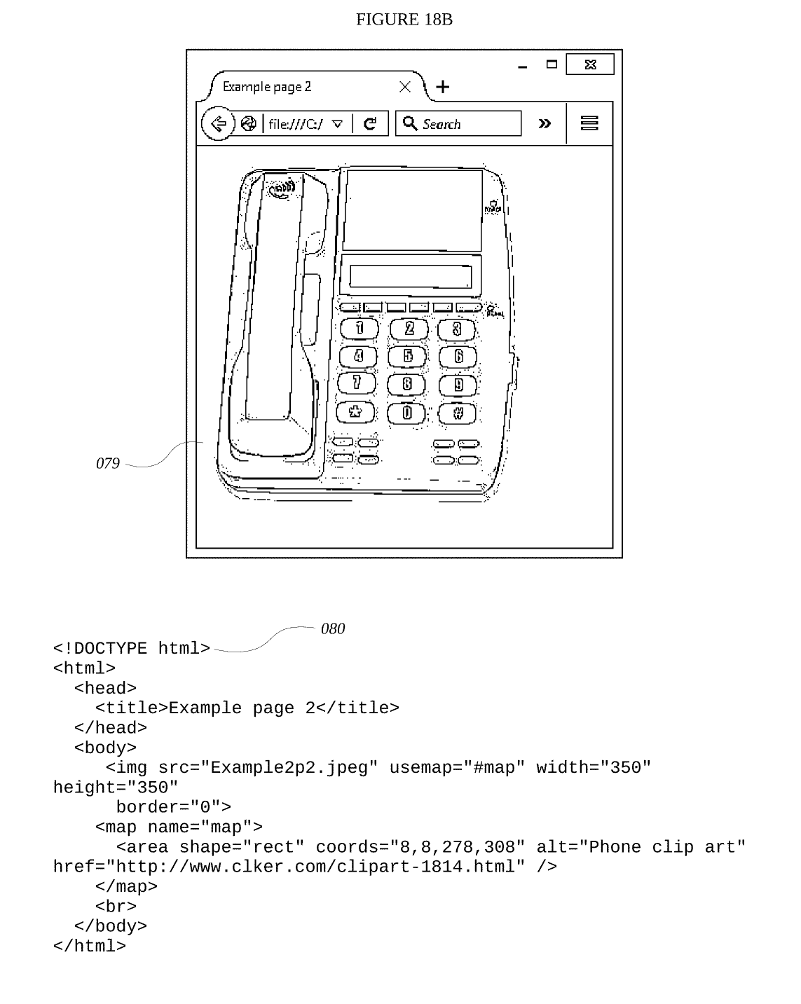

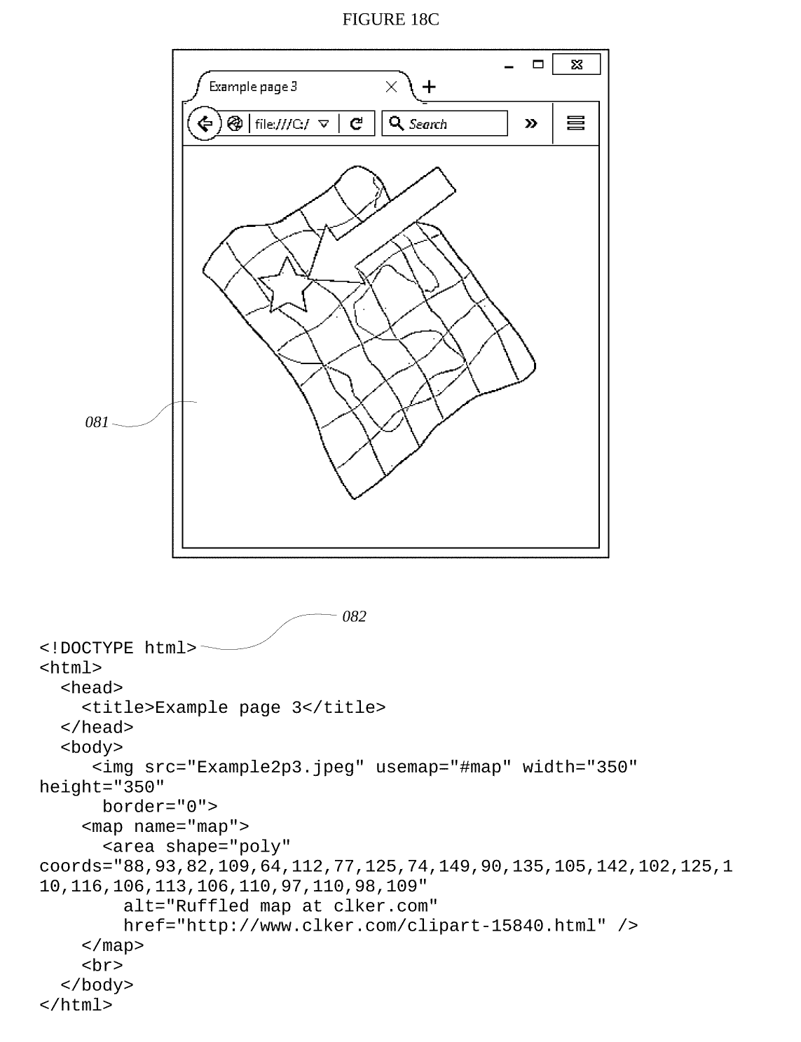

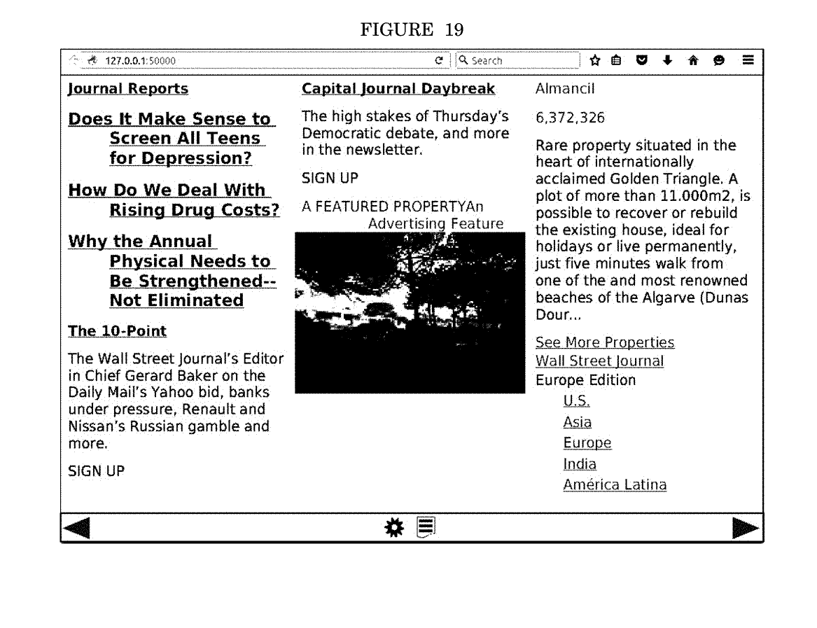

FIGS. 18A to 18C illustrate another possible outcome of an embodiment of the invention with a set of screen page images converted from the styled text and graphical elements as set out in FIG. 11. FIG. 18A shows an illustration of a Web browser displaying an automatically produced JPEG screen page image 077 of one possible output of the an embodiment of the invention. The related HTML code 078 instructing a Web browser is another possible output so produced. Such HTML code may cause a screen page image to be downloaded to end user computing device(s) and contains an image map to support end user interaction (in this case the interaction area encompasses underlined writing).

FIG. 18B shows an illustration of a Web browser displaying a JPEG screen page image 079 as a further example of the possible output which may be automatically produced by an embodiment of the invention, along with further HTML code 080, which together constitute the next image page in a sequence. In this case the image map in the HTML code makes the portion of the screen page image depicting the telephone into an interaction area with link information to be acted upon by a browser if that area is selected by an end user.

FIG. 18C shows an illustration of a Web browser displaying a JPEG screen page image 081 as yet a further example of the possible automatic output of an embodiment of the invention, along with more further HTML code 082, which together constitute the last image page in a sequence. In this case, the image map in the HTML code makes only the star in the depiction of the treasure map an area of end user interaction, with link information to be acted upon by the browser if that area is selected.

FIG. 19 illustrates the output of an example embodiment of the invention as a multi-column display shown in a Web browser. In this case three screen page images are shown within a Web application that controls the navigation by way of clickable arrows at the bottom of the Web application. In this example, each of the screen page images occupies its own HTML iFrame and each iFrame has been loaded with a corresponding image map to enable information links. This arrangement has the advantage of allowing each column to load separatelty so the column on the left for example, could be loaded first to enable letf-to-right reading to start before the others are downloaded by the Web browser.

It will be appreciated however, that this is not the only way such a Web presentation could work, as may be understood by the following non-limiting examples: the three columns could be depicted in a single screen page image with one corresponding image map for them all. Alternatively, the navigation and other controls could be provided as a separate image with a corresponding image map; or the control image(s) and interaction(s) area(s) data could be appended to the screen page image and its corresponding image map accordingly.

For ease of explanation, FIGS. 2, 3, 4, 5 and 10 exemplify sequential programmatic page processing but it will be appreciated that pages may be processed in any order, such as one page at a time as may be appropriate.

It will be further appreciated that in some cases, to conserve resources, increase security or where the information being presented is not often required, the persistence of screen page images/interaction(s) area(s) specification(s) (such as defined by image map(s)) in computer memory may be limited to only enable once-off or time-limited presentations of information. The level of perseistance may be determined by reference to security data associated with Publisher Document(s) 001.

Without limitation, it will also be further appreciated that more than one interaction(s) area(s) specification may be persisted together, in a single file for example.

In some embodiments the term “suitably paginated” and the like may mean as a single page (with only the width being specified, as exemplified in FIGS. 16 & 17) if a scrolling Document interface is required similar to a traditional Web page, with the height being found upon the layout of Content Elements.

It will also be appreciated that in some cases the various computer systems mentioned in the descriptions of the invention may be substituted with specific purpose computer(s), such as where machine instructions enabling an embodiment of the invention (or part thereof) may be part of the architecture of a central processing unit(s) for greater efficiency or Read Only Memory ROMs (e.g. optical or silicone chip) for greater security. Likewise, Documents and data may be similarly “hard wired” in ROMs to ensure integrity or survivability.

Throughout this specification, unless the context indicates otherwise, it is intended that various aspects features and functions as exemplified in the forms and embodiments of the invention described above, may as required, be present in an exemplary embodiment. Likewise to avoid doubt, and where the context permits, the phrase “such as” should be broadly interpreted to mean “such as but not limited to”.

The invention uniquely eliminates the long-standing requirement for prior agreement between computer systems about fonts and encodings outside the Publisher(s)' computer systems, which otherwise sometimes results in styled text being scrambled. Additionally, because the invention persists rasterisation of styled hypertext and/or interactive graphical elements, more consistent information presentation across all end user computing devices can be achieved than by relying on the many different rasterisers in those devices. The invention may also support large numbers of fonts in a single Document without the problems of font-substitution or the bloat of downloadable fonts with their attendant security risks. The invention can also increase security by enhancing Publisher control over information, since the invention utilises no text (characters) display for its main output; and without limitation, certain embodiments may not require any JavaScript or like-programming of end user computing devices.

The invention may achieve all this by transforming styled hypertext and/or interactive graphical element(s)—as found in billions of Documents worldwide—into screen page image files(s) with coordinates relative to each page and actions in the form of link data, to support end user interaction leading to further action(s) being taken. This can be achieved using standards-based outputs that makes the invention's re-pagination output easy to reliably integrate with various computer systems and programs. The invention does not require browser plugins or applets—which are becoming less acceptable due to security issues and unavailability—so it can free information from the problems of encoding, formatting, font issues and content element interference, while preserving internal and external hyperlink capabilities. This can maximise distribution opportunities for Publishers while maintaining an enhanced or trouble-free reading experience for other users.

The following claims are herein incorporated by reference into this detailed description:

1. A computer system acting as display device means that displays persistent screen page image(s) and acts on associated interaction(s) area(s) specification(s) after:
(a) said screen page image(s) with associated interaction(s) area(s) specification(s) have by a server processing means on another computer system, been created automatically, by:
paginating an unpaginated electronic Document or re-paginating a differently paginated electronic Document into page(s), for viewing within information viewing area(s) on the said display device means, and
rasterising said paginated or re-paginated electronic Document page(s) into said screen page image(s), and
seeking and recording any interaction(s) area(s) data corresponding with styled hypertext or ascertained from interactive graphical elements in said paginated electronic Document, and
compiling any interaction(s) area(s) data into interaction(s) area(s) specification(s), and
associating said screen page image(s) with corresponding said interaction(s) area(s) specification(s), and
persisting said screen page image(s) with associated interaction(s) area(s) specification(s) in computer memory;
(b) said automatically created screen page image(s) with associated interaction(s) area(s) specification(s) have been communicated from the said server processing means to the said display device means;
and wherein at least one said electronic Document page to be paginated has one or more of styled-hypertext or a plurality of interactive graphical elements or a plurality of placeholders or any two or more of styled-hypertext, interactive graphical elements, and placeholders.

2. The system of claim 1 wherein one or more content elements in said electronic Document is referenced to word numbers which are associated with said screen page images to allow search on content elements to return said screen page image(s) of relevance from said server means to said display device means.

3. The system of claim 1 wherein magnification of pagination is adjusted by using pinching/expanding screen gestures, allowing preview and manipulation of magnification to suit before magnification pagination is invoked.

4. The system of claim 3 wherein new page(s) to be created by said magnification pagination may have a different aspect ratio (such as by reducing the number of columns of screen page images shown at once on the said display device means's display area) to suit..

5. The system of claim 1 wherein the said server means communicates at least one said screen page image by way of a plurality of files with said files each representing only part of a said screen page image.

6. A computer-implemented process of automatic persistent screen page image and end-user interaction areas(a) specification(s) creation, where:
(a) an electronic Document is obtained from computer memory or other digital source; and
(b) said electronic Document is paginated if unpaginated or re-paginated to a different pagination into one or more page(s) using page dimensions suitably sized to be viewed within information viewing area(s) of end-user computing device(s) or within program(s) running on such; and
(c) said suitably paginated electronic Document pages are processed so that:
location(s) and dimensions of any content elements having link data are detected and recorded relative to the respective page(s) of such content element(s), and
said recorded locations and dimensions of each of said content elements are associated with corresponding link data of each of said content elements to create interaction(s) area(s) data, and
one or more said interaction(s) area(s) data are compiled as interaction(s) area(s) specifications(s); and
(d) at least one said suitably paginated electronic Document page(s) are rasterised to produce persistent screen page image(s) as pixmap file(s) which visually correspond to said paginated electronic Document page(s); and
(e) copy(s) of said persistent screen page image(s), and copy(s) of said related persistent interaction(s) area(s) specification(s) are communicated via a computer netorwok for display in one or more said information viewing areas;
and whereby at least one said Document page to be paginated has one or more of styled-hypertext or a plurality of interactive graphical elements or a plurality of placeholders or any two or more of styled-hypertext, interactive graphical elements, and placeholders.

7. The process of claim 6 wherein interaction(s) area(s) data is updated on the said end-user computing device via the said computer network after additional data pertaining to an internal reference has been determined.

8. The process of claim 6 wherein said suitable pagination includes associating screen page image(s) with a reference to content element(s) found in their respective corresponding said electronic Document page(s) and recording said reference(s) in persistent computer memory for the purposes of fuzzy bookmarking or finding information.

9. A computer-implemented method of automatic persistent screen page image(s) creation in conjunction with persistent interaction(s) area(s) specification creation including the steps of:
Paginating an unpaginated electronic Document or more suitably re-paginating an electronic Document (obtained from a repository or other digital source) into one or more pages having dimensions suited to information viewing area(s) belonging to one or more end user computing devices or programs thereof; and then:
Rasterising said paginated electronic Document page(s) to create screen page image(s) of at least one said page and persisting said screen page image(s) in one or more pixmaps;
Identifying any styled hypertext, or any interactive graphical element(s), in said paginated electronic Document pages(s);
Analysing any said identified styled hypertext or interactive graphical element(s) or the said electronic Document to obtain and record the geometric disposition of hotspots relative to the said paginated electronic Document page(s) or pixmap(s) having screen page images;
Associating said recording(s) with the link data of each of the said styled hypertext or interactive graphical element(s) so as to create interaction(s) area(s) data;
Combining and persisting said interaction(s) area(s) data as interaction(s) area(s) specification(s) in a way related to said screen page image(s);
Making said screen page image(s) and said related interaction(s) area(s) specification(s) available to one or more end user computing devices via a computer network;
and whereby at least one said Document page to be paginated has one or more of styled-hypertext or a plurality of interactive graphical elements or a plurality of placeholders or any two or more of styled-hypertext, interactive graphical elements, and placeholders.

10. The method of claim 9 whereby if the said electronic Document contains bookmark(s) then each bookmark's link data or the link data associated with the geometric disposition of each bookmark, will refer to the relevant screen page image(s) produced by the said rasterising step.)

11. The method of claim 1 whereby magnification of pagination is adjusted by using pinching/expanding screen gestures on said information viewing area(s). to allow preview and manipulation of magnification to suit before magnification pagination is invoked, and whereby new page(s) to be created by said magnification pagination may have a different aspect ratio (such as by reducing the number of columns of screen page images shown at once on the said information viewing area(s) to suit.

12. The method of claim 9 whereby content elements in a said paginated electronic Document are referenced to word numbers which are associated with said screen page images to allow users of said end user computing devices to request information and have relevant page image(s) communicated to the said end user computing device.

13. The method of claim 9 with the further steps of the server means communicating at least one said screen page image by way of a plurality of files with each said file representing part of said screen page image, with said plurality of files being presented by a said end user computing device as one or more said screen pages not easily be saved by an end user as a single file.

14. The method of claim 9 whereby said link data pertaining to a an internal reference (such as bookmark or anchor) is provided for said interaction(s) area(s) data associated with one or more said screen page image(s) only when additional data pertaining to the internal reference becomes known some time after said screen page image(s) and said related interaction(s) area(s) specification(s) is made available to one or more end user computing devices via a computer network.

15. The claims of 1, 6 or 9 such that if a page in a said electronic Document is a whole page image it is converted using optical recognition into text and/or graphical elements so that the page is no longer a whole page image.
